(19) United States
(12) Patent Application Publication
(10) Pub. No.: US 2014/0255520 A1
(43) Pub. Date: Sep. 11, 2014

(54) Methods of Using Solutions of Hypobromous Acid and Hypobromite to Treat Poultry in a Chill Tank During Processing to Increase the Weight of the Poultry

(71) Applicants: Michael S. Harvey, Modesto, CA (US); Jonathan N. Howarth, Modesto, CA (US)

(72) Inventors: Michael S. Harvey, Modesto, CA (US); Jonathan N. Howarth, Modesto, CA (US)

(21) Appl. No.: 14/283,155

(22) Filed: May 20, 2014

Related U.S. Application Data
(62) Division of application No. 13/507,498, filed on Jul. 5, 2012, now abandoned.
Application No. 13/507,498 is a continuation-in-part of application No. 12/925,301, filed on Oct. 19, 2010.
Application No. 12/925,301 is a continuation-in-part of application No. 12/658,916, filed on Feb. 16, 2010.
Application No. 13/507,498 is a continuation-in-part of application No. 13/199,029, filed on Aug. 16, 2011.

(51) Int. Cl. A01N 59/00; A23L 1/315; A01N 25/02

(52) U.S. Cl. CPC A01N 59/00; A01N 25/02; A23L 1/3155
USPC 424/723

(57) ABSTRACT

Methods for treating poultry to increase the weight of the poultry are disclosed. The methods may be performed in a chill tank or other reservoir and utilize hypobromous acid from either aqueous hydrogen bromide or aqueous sodium bromide and a source of hypochlorite. The methods comprise contacting a poultry carcass with the hypobromous acid-containing water at a pH of about 6.5 to about 10. The methods result in an increase in the weight of the processed poultry products.

### CROSS-REFERENCE TO RELATED APPLICATIONS

Pursuant to 35 U.S.C. §§120 and 121, this application is a divisional of and claims priority to co-pending U.S. patent application Ser. No. 13/507,498 filed on Jul. 5, 2012, the entire disclosure of which is incorporated herein by reference. Pursuant to 35 U.S.C. §120, U.S. patent application Ser. No. 13/507,498 is a continuation-in-part of and claims priority to co-pending U.S. patent application Ser. No. 12/925,301 filed on Oct. 19, 2010, which is a continuation-in-part of and claims priority to co-pending U.S. patent application Ser. No. 12/658,916 filed on Feb. 16, 2010, the entire disclosures of which are incorporated herein by reference. Pursuant to 35 USC §120, U.S. patent application Ser. No. 13/507,498 is also a continuation-in-part of and claims priority to U.S. patent application Ser. No. 13/199,029 filed on Aug. 16, 2011, the entire disclosure of which is incorporated herein by reference.

### FIELD OF THE INVENTION

The invention relates to methods of using solutions of hypobromous acid and hypobromite to chill poultry during processing for increasing the weight of the poultry.

### BACKGROUND OF THE INVENTION

Poultry is typically processed by the following steps. Live birds packed in cages are delivered to a processing plant's holding area. The cages are transported by conveyor to a live hang area and are manually unloaded. The birds are hung by their feet to a shackle conveyor. The conveyor moves the birds through an electrified water tank or an electrified cabinet where they are stunned. The birds are then slaughtered and exsanguinated. They are then conveyed through a hot water scald tank at 123-140° F. for 30 to 90 seconds to loosen their feathers. A mechanical device then removes the feathers. The head and feet are removed and the birds are eviscerated. Each carcass and its internal organs are then inspected by United States Department of Agriculture (USDA) officials. If the carcass and internal organs are deemed healthy and free of fecal and digestive tract matter, the carcass is conveyed into a poultry chill tank.

If the carcass contains fecal or digestive tract matter, the carcass is further processed before being placed in the poultry chill tank. Depending on the size of the fecal or digestive tract matter, the carcass is directed to on-line reprocessing or off-line reprocessing, where it is sprayed with water containing a disinfectant or antimicrobial agent to remove the contamination. Following this reprocessing, the carcass is conveyed into the poultry chill tank.

The chill tank, sometimes referred to as the main or primary chill tank, is filled with near-freezing water and is used to cool the carcasses prior to further processing or packaging. The purpose of cooling the carcasses is to arrest the proliferation of pathogenic and spoilage microorganisms, such as Salmonella, Campylobacter, yeast, and molds. The carcasses move through the chill tank by means of flights on a large, slowly rotating auger. The residence time in the tank is typically about 45 minutes for chickens, but it can be up to three hours for larger birds such as turkeys. The water in the chill tank contains a disinfectant or antimicrobial agent to prevent cross-contamination of microorganisms between the carcasses, and to eradicate or reduce microorganisms still resident on the carcasses. A portion of the water in the chill tank is bled off or removed from the chill tank in order to keep the level of contaminants down. The bled off water may be discarded as waste or reused in an upstream (earlier) processing step. Additional water, referred to as make-up water, is added to the chill tank to maintain the volume of water in the chill tank.

Prior to the chill tank, some processing plants use a prechill tank to soak the carcasses in before placing them into the main chill tank. One purpose of the prechill tank is to begin lowering the temperature of the carcasses early in the processing of the poultry. Typically, the water bled from the main chill tank is used in the prechill tank. Thus, the disinfectant used in the main chill tank also serves as a disinfectant in the prechilll tank.

Some processing plants use a finishing chill tank to soak the carcasses in after they are removed from the main chill tank. The purpose of the finishing chill tank is to give the carcasses a final sanitization. Like the main chill tank, the finishing chill tank also contains near-freezing water, but its smaller volume allows the plants to use a higher concentration of disinfectant than is used in the main chill tank. The residence time is typically less than one minute. The water bled from the finishing chill tank may be used in the main chill tank. Thus, the disinfectant used in the finishing chill tank also serves as a disinfectant in the main chill tank.

The carcasses are removed from the main chill tank, or from the finishing chill tank if one is used. They are then sent for packaging as whole birds. Or, if the carcasses are intended to be sold as pieces, they are placed on ice for about three hours and then cut up and sorted.

Poultry processors purchase the birds by weight, and also sell the processed products by weight. The typical poultry processing plant in the United States processes about 250,000 live birds per day and produces about 1,000,000 lbs of processed products per day. The weight of the processed products, however, is less than the weight of the live birds, for several reasons, including that various parts of the bird are discarded. Because the processors sell the processed products based on weight, it is important for the processors to maximize the weight of the processed products.

Poultry processors are regulated by the Food Safety Inspection Service (FSIS), a division of the USDA. The FSIS sets strict standards for microbiological control of the birds. Any disinfectant or antimicrobial agent that contacts the birds must be approved by the FSIS. The chill tank is the largest Hazard Analysis Critical Control Point (HACCP) exposure in the processing plant. Thus, the chill tank must perform as intended to cool the carcasses and must also maintain a high degree of microbiocidal efficacy to meet the standards of the FSIS.

Chlorine in the form of sodium hypochlorite solution has long been the primary disinfectant used to treat the poultry chill tank water in United States processing operations. However, the use of chlorine has declined because it cannot meet the increasingly higher standards set by the FSIS, it is very corrosive to metals, and it tends to develop volatile chlorinated lachrymators which are deleterious to plant workers in the vicinity of the chill tank.

Currently, two of the most commonly used disinfectants or antimicrobial agents that are approved by the FSIS for use in poultry chill tanks are bromine, in the form of hypobromous acid, and equilibrium solutions of peracetic (peroxyacetic) acid. The concentration of hypobromous acid typically employed in poultry chill tanks is less than 100 ppm (as Br₂), and most typically between 25-40 ppm (as Br₂).

There are three methods of introducing hypobromous acid to a poultry chill tank. The first method utilizes solid 1,3-dibromo-5,5-dimethylhydantoin which dissolves in water to release hypobromous acid. In the second method, a solution of sodium hypochlorite is mixed with aqueous hydrogen bromide outside the system being treated to form a solution of hypobromous acid which is then pumped into the water to be treated. The third method involves mixing a solution of sodium hypochlorite with aqueous sodium bromide (and optionally a source of a mineral acid) outside the system being treated to form a solution of hypobromous acid which is then pumped into the water to be treated.

When any of these three methods are used to generate a hypobromous acid disinfectant for the treatment of poultry chill tank water, the pH of the water naturally becomes acidic. This is because the reactions of hypobromous acid with the organic contaminants introduced with the birds are proton-generating. Thus, although the chill tank water containing the hypobromous acid may have a neutral pH before introduction of the birds, by the end of the working day, the water typically has a pH of less than 4.5.

Similarly, when an equilibrium solution of peracetic acid is used, the pH of the chill tank water is about 4.5 to about 5.5.

Thus, in poultry chill tank water treated with either hypobromous acid or with peracetic acid, the pH of the water becomes acidic. The poultry processing industry views this low pH range as advantageous because it is accepted in the industry that bacteria and other microorganisms are more readily destroyed at lower pH values. An added advantage of acidic conditions is that under acidic conditions both hypobromous acid and peracetic acid are more stable (i.e., degrade more slowly), and are therefore more cost-effective to use.

### SUMMARY OF THE INVENTION

In one aspect, an embodiment of the invention provides a method of treating at least a portion of a poultry carcass for increasing the weight of the poultry, said method comprising: combining water and an antimicrobial amount of an aqueous solution of hypobromous acid for forming a hypobromous acid-containing water having a pH of about 6.5 to about 10; and bringing at least a portion of a poultry carcass into contact with the hypobromous acid-containing water for increasing the weight of at least the portion of the poultry carcass from a first weight prior to contact with the hypobromous acid-containing water to a second weight greater than the first weight after contact with the hypobromous acid-containing water.

In another aspect, an embodiment of the invention provides a method of treating at least a portion of a poultry carcass for increasing the weight of the poultry, said method comprising: providing, in a reservoir, a hypobromous acid-containing water having a pH of about 6.5 to about 10, wherein the hypobromous acid-containing water comprises water and an antimicrobial amount of an aqueous solution of hypobromous acid, and wherein the hypobromous acid-containing water has a temperature; placing into the hypobromous acid-containing water at least a portion of a poultry carcass having a first weight and having a first temperature greater than the temperature of the hypobromous acid-containing water; allowing the hypobromous acid-containing water having the pH of about 6.5 to about 10 to increase the first weight of at least the portion of the poultry carcass to a second weight greater than the first weight to provide an increased weight of at least the portion of the poultry carcass and to lower the first temperature of at least the portion of the poultry carcass to a second temperature less than the first temperature for cooling at least the portion of the poultry carcass; and removing at least the portion of the poultry carcass having the increased weight from the hypobromous acid-containing water.

In another aspect, an embodiment of the invention provides a method of treating at least a portion of a poultry carcass for increasing the weight of the poultry, said method comprising: combining water and an antimicrobial amount of an aqueous solution of hypobromous acid for forming a hypobromous acid-containing water; determining the pH of the hypobromous acid-containing water, and, if the pH is determined to be lower than about 6.5 or higher than about 10, then altering the pH of the hypobromous acid-containing water to a pH of about 6.5 to about 10; bringing at least a portion of a poultry carcass into contact with the hypobromous acid-containing water; and determining the pH of the hypobromous acid-containing water with at least the portion of the poultry carcass therein, and, if the pH is determined to be lower than about 6.5 or higher than about 10, then altering the pH of the hypobromous acid-containing water to a pH of about 6.5 to about 10, for increasing the weight of at least the portion of the poultry carcass from a first weight prior to contact with the hypobromous acid-containing water to a second weight greater than the first weight after contact with the hypobromous acid-containing water.

In another aspect, an embodiment of the invention provides a method of treating at least a portion of a poultry carcass for increasing the weight of the poultry, said method comprising: providing, in a reservoir, a hypobromous acid-containing water, wherein the hypobromous acid-containing water comprises water and an antimicrobial amount of an aqueous solution of hypobromous acid, and wherein the hypobromous acid-containing water has a temperature; determining the pH of the hypobromous acid-containing water, and, if the pH is determined to be lower than about 6.5 or higher than about 10, then altering the pH of the hypobromous acid-containing water to a pH of about 6.5 to about 10; placing into the hypobromous acid-containing water at least a portion of a poultry carcass having a first weight and having a first temperature greater than the temperature of the hypobromous acid-containing water; determining the pH of the hypobromous acid-containing water in the reservoir with at least the portion of the poultry carcass therein, and, if the pH is determined to be lower than about 6.5 or higher than about 10, then altering the pH of the hypobromous acid-containing water to a pH of about 6.5 to about 10; allowing the hypobromous acid-containing water having the pH of about 6.5 to about 10 to increase the first weight of at least the portion of the poultry carcass to a second weight greater than the first weight to provide an increased weight of at least the portion of the poultry carcass and to lower the first temperature of at least the portion of the poultry carcass to a second temperature less than the first temperature for cooling at least the portion of the poultry carcass; and removing at least the portion of the poultry carcass having the increased weight from the hypobromous acid-containing water.

### BRIEF DESCRIPTION OF THE DRAWINGS

FIG. 1 is a schematic representation of an example of a system that may be used to continuously or intermittently generate a solution of hypobromous acid using an aqueous solution of hydrogen bromide for use in a poultry chill tank.

FIG. 2 is a schematic representation of an example of a system that may be used to continuously or intermittently generate a solution of hypobromous acid using an aqueous solution of sodium bromide for use in a poultry chill tank.

FIG. 3 is a graph showing the average percent weight gain of poultry as a function of pH (pH range 6.5-10) when contacted with a solution of hypobromous acid (100 ppm as Br₂) prepared by combining aqueous hydrogen bromide and sodium hypochlorite solutions.

FIG. 4 is a graph showing the average percent weight gain of poultry as a function of pH (pH range 6.5-10) when contacted with a solution of hypobromous acid (1 ppm as Br₂) prepared by combining aqueous hydrogen bromide and sodium hypochlorite solutions.

FIG. 5 is a graph showing the average percent weight gain of poultry as a function of pH (pH range 6.5-10) when contacted with a solution of hypobromous acid (100 ppm as Br₂) prepared by combining aqueous sodium bromide and sodium hypochlorite solutions.

FIG. 6 is a graph showing the average percent weight gain of poultry as a function of pH (pH range 6.5-10) when contacted with a solution of hypobromous acid (1 ppm as Br₂) prepared by combining aqueous sodium bromide and sodium hypochlorite solutions.

### DETAILED DESCRIPTION OF THE INVENTION

### 1. Definitions

The term “hypobromous acid” means either hypobromous acid or a mixture of hypobromous acid and its conjugate base, hypobromite ion.

The term “carcass” means the dead body of a bird, after exsanguination and after removal of the feathers, viscera, head, and feet.

The terms “percent” and “%” mean weight percent, except when referring to the percent converted.

The term “point-of-use” means the location where the solution of hypobromous acid enters the receiving water.

The terms “poultry” and “bird” mean any bird, including chicken, turkey, duck, goose, ostrich, pheasant, squab, and other birds.

The terms “poultry chill tank” and “chill tank” mean the main or primary chill tank in a poultry processing plant.

The term “receiving water” means the water that is being treated with a hypobromous acid disinfectant (e.g., the water in a poultry chill tank).

The term “reservoir” means a container for holding water (e.g., a poultry chill tank).

### 2. Experimental Methods

In the description of the embodiments of the invention set forth below, references are made to three methods or techniques that were used to quantify or differentiate halogen levels for the microbiology and storage stability studies described herein. The techniques are: iodometric titration, an N,N-diethyl-p-phenylenediamine (DPD) Total Halogen Colorimetric Method, and a DPD Differentiation Colorimetric Method (also known as the Palin Modification), each of which is set forth below.

A. Iodometric Titration Method

The iodometric titration is a technique that allows for the determination of the total halogen present in any given system and is usually the method of choice when concentrated halogen solutions are prepared. This technique does not allow for the differentiation between the halogens e.g. how much is present as bromine and how much is present as chlorine. Therefore, the halogen levels determined by the iodometric method are usually expressed in terms of “as chlorine” or “as bromine” even though the system may contain a mixture of both bromine and chlorine.

A typical iodometric titration is performed as follows. A sample of the halogen-containing solution is accurately weighed (4 decimal places) to a beaker, then deionized water (DI) or reverse osmosis (RO) water is added to the beaker. Using a magnetic stir bar to ensure appropriate mixing, add approximately 5 ml of 80% acetic acid and approximately 1 g potassium iodide crystals to the beaker. Mix the solution and allow the potassium iodide crystals to dissolve. The solution will turn a dark yellow/red color as the bromine or chlorine or both, oxidize the iodide ion to liberate iodine. Under acidic conditions, aqueous halogen-containing solutions quantitatively liberate iodine from excess potassium iodide. The liberated iodine is titrated with a standard solution of 0.1000N sodium thiosulfate (Na₂S₂O₃) until the solution turns a faint straw color. The faint straw color indicates the titration is near its end-point. Starch indicator (1 ml of 0.5% starch) is then introduced to the titration flask so that the solution changes from pale straw yellow to black or dark blue. This is the color of the complex that forms between starch and iodine. The more intense blue/black color serves to sharpen the end-point. Continue to titrate drop by drop until the blue/black color is completely discharged and the solution is colorless. The volume (V) of 0.1000N sodium thiosulfate titrant required to affect the end-point is used to calculate the activity of the halogen-containing solution.

To calculate the total halogen present, the following equation is used to express the results as weight % as Cl₂:

$$Wt \% as {Cl}_{2} = \frac{V \text{/} ml \times N {Na}_{2} {S}_{2} {O}_{3} \times 0.03545 \times 100}{Wt . of sample \text{/} g}$$

To express the results as weight % as Br₂, calculate the weight % as Cl₂ and multiply the result by 2.25. Example: 10.2% as Cl₂=10.2×2.25=22.95% as Br₂.

B. DPD Total Halogen Colorimetric Method

The DPD Total Halogen Method is similar to the iodometric titration in that it also is limited to detecting the total halogen level in an aqueous system, but is more accurate when low levels of total halogen are present. A typical DPD Total Halogen Method is performed as follows.

A HACH DR/700 Colorimeter (or equivalent) is utilized for the analysis. To analyze the concentration of halogen as total chlorine on the HACH DR/700 Colorimeter, module number 52.01 (525 nm) should be installed and used in conjunction with HACH Method number 52.07.1. The instrument must be set to the low (LO) range mode so that the display reads to the hundredths place (0.00). Make an appropriate dilution with reverse osmosis (RO) or deionized (DI) water. Fill two sample cells with 10 ml of the diluted sample. Designate one of the cells to be the “blank” and the other to be the prepared sample. Dry the outside of both cells with a paper towel or cloth and make sure the cells are free of fingerprints or smudges. Cap the blank cell and place it into the cell holder with the diamond mark facing you. Cover the cell compartment and press ZERO. The instrument will display 0.00. Remove the “blank” at this time. Add the contents of one DPD Total Chlorine pillow pack (for a 10 ml sample volume) to the prepared sample cell. Cap and shake vigorously. A pink color will develop indicating the presence of halogen. Immediately place the sample cell in the compartment with the diamond facing you, cover the cell compartment and press READ. The instrument display will flash “ - - - ” followed by the results in ppm total chlorine.

No calculation is needed to determine the total halogen present as chlorine; the instrument reading is the ppm total Cl₂. To express the results as ppm Br₂, multiply the result by 2.25. (Multiply both results by the dilution factor in order to obtain the halogen concentration in the undiluted solution).

C. DPD Differentiation Colorimetric Method (Also Known as the Palin Modification)

In order to determine how much of the halogen is present as bromine and how much is present as chlorine, the DPD Differentiation Method (also known as the Palin Modification) is utilized. This method allows for the differentiation and quantification of bromine and chlorine in a solution. A typical DPD Differentiation Method is performed as follows.

A HACH DR/700 Colorimeter is utilized for this testing. To analyze the concentration of halogen as free chlorine on the HACH DR/700 Colorimeter, module number 52.01 (525 nm) should be installed and used in conjunction with HACH Method number 52.05.1. The instrument must be set to the low (LO) range mode so that the display reads to the hundredths place (0.00). Make an appropriate dilution. For example, testing a theoretical 300 ppm as Br₂ solution, weigh out 97.0 g distilled water, exactly 1.00 g of solution containing the theoretical 300 ppm as Br₂, and 2.0 g of a 10% glycine solution. The diluted solution is then well mixed in order to bind any free chlorine present into the form a combined form of chlorine, N-chloroglycine. Fill two sample cells with 10 ml of the diluted sample containing the glycine. Designate one of the cells to be the “blank” and the other to be the prepared sample. Dry the outside of both cells off and make sure both cells are free of fingerprints or smudges. Cap the blank cell and place it into the cell holder with the diamond mark facing you. Cover the cell compartment and press ZERO. The instrument will display 0.00. Remove the “blank” at this time. Add the contents of one DPD Free Chlorine pillow pack (for a 10 ml sample size) to the prepared sample. Cap and shake vigorously. A pink color will develop indicating the presence of bromine. Place the sample cell in the compartment with the diamond facing you, close the cover and press READ. The instrument display will flash “ - - - ” followed by the results in expressed in ppm free chlorine. This reading is designated “B” and represents the amount of bromine present in the solution in the form of hypobromous acid and/or mixture of hypobromous acid and hypobromite. Remove the sample cell from the compartment and add a small amount of potassium iodide (KI) crystals (2-3 crystals) to the prepared sample cell still containing the sample, and vigorously shake. This step allows any glycine-bound chlorine to react with the KI, liberate iodine, which then reacts with the DPD indicator to intensify the pink coloration. Place the sample cell back in the compartment with the diamond mark facing you, close the cover and press READ. The results represent total halogen expressed as ppm free chlorine. This reading is designated “TH.” The difference (TH-B) represents the amount of chlorine present that may accompany the bromine content.

### 3. Methods of Using Hypobromous Acid to Treat Poultry During Processing for Increasing the Weight of the Poultry

A. Methods Utilizing Hydrogen Bromide

In an embodiment, a method of treating at least a portion of a poultry carcass for increasing the weight of the poultry utilizes hypobromous acid. The method comprises:
(a) Combining water and an antimicrobial amount of an aqueous solution of hypobromous acid for forming hypobromous acid-containing water having a pH of about 6.5 to about 10.

The hypobromous acid solution may be prepared by mixing an aqueous solution of hydrogen bromide and a source of hypochlorite with water. Appropriate sources of hypochlorite include a solution of sodium hypochlorite, a solution of potassium hypochlorite, solid calcium hypochlorite, and solid lithium hypochlorite. Preferably, the aqueous hydrogen bromide and the source of hypochlorite are mixed in a mole ratio of about 1 to about 1 to form a solution of hypobromous acid containing about 50 to about 30,000 ppm as Br₂.

The water and the hypobromous acid solution are combined to form hypobromous acid-containing water. An antimicrobial amount of hypobromous acid is used. The amount is sufficient to prevent cross-contamination of bacteria between the poultry carcasses and to eradicate or reduce any pathogenic or spoilage microorganisms still resident on the carcasses. The amount of hypobromous acid that is used depends on the microbiological condition of the carcasses, but should sufficient to provide about 1 ppm to about 99 ppm as Br₂ in the hypobromous acid-containing water. Any suitable method of analyzing the amount of hypobromous acid in the water can be used. These methods include test strips which change color depending on the amount hypobromous acid present, and the analytical methods described above in Experimental Methods.

The pH of the hypobromous acid-containing water that is formed is about 6.5 to about 10.
(b) Bringing at least a portion of a poultry carcass into contact with the hypobromous acid-containing water for increasing the weight of at least the portion of the poultry carcass from a first weight prior to contact with the hypobromous acid-containing water to a second weight greater than the first weight after contact with the hypobromous acid-containing water.

A portion of a poultry carcass is brought into contact with the hypobromous acid-containing water. This may be accomplished by placing the carcass in a reservoir with the hypobromous acid-containing water, or by other methods, such as by passing the carcass through the hypobromous acid-containing water. Before it is brought into contact with the hypobromous acid-containing water, the poultry carcass has a specific weight, referred to as a first weight. After contact with the hypobromous acid-containing water, the poultry carcass has a specific weight, referred to as a second weight, which is greater than the first weight.

Optionally, before the step of bringing at least the portion of the poultry carcass into contact with the hypobromous acid-containing water, a step of determining the pH of the hypobromous acid-containing water and a subsequent step of altering the pH may be performed. The pH of the hypobromous acid-containing water is determined by any method, including the use of a glass electrode, indicator solutions, and pH test strips. If the pH is determined to be about 6.5 to about 10, then no pH-altering step is performed and the step of bringing at least the portion of the poultry carcass into contact with the hypobromous acid-containing water is performed next. If the pH is determined to be lower than about 6.5 or higher than about 10, then a subsequent pH-altering step is performed. If the pH is determined to be lower than about 6.5, then a source of alkali is added to the hypobromous acid-containing water to raise the pH of the hypobromous acid-containing water to about 6.5 to about 10. Any suitable source of alkali may be used. Examples include, but are not limited to, alkali metal or earth alkali metal carbonates, bicarbonates, oxides, and hydroxides. When solutions are preferred, sodium hydroxide or potassium hydroxide solutions are convenient to use, alone or in combination with each other. A preferred alkaline source is 50% NaOH solution. To prevent crystallization problems upon storage in cold climates, the 50% NaOH solution may be diluted with water and then used. If the pH is determined to be higher than about 10, then a source of acid is added to the hypobromous acid-containing water to lower the pH of the hypobromous acid-containing water to about 6.5 to about 10. Any suitable source of acid may be used. Inorganic acids are preferred because they are less expensive than organic acids and possess higher pH-lowering properties. Suitable inorganic acids include solutions of sulfuric acid, hydrochloric acid, phosphoric acid, nitric acid, and sodium hydrogen sulfate. Preferable inorganic acids are phosphoric acid and sodium hydrogen sulfate because they are FDA-approved for food contact purposes. Organic acids may be used, and include citric acid and lactic acid, which are FDA-approved. After altering the pH, the step of bringing at least a portion of a poultry carcass into contact with the hypobromous acid-containing water is performed next.

Also, optionally, after the step of bringing at least a portion of a poultry carcass into contact with the hypobromous acid-containing water, a step of determining the pH of the hypobromous acid-containing water and a subsequent step of altering the pH may be performed. This pH-determining and pH-altering step is performed in the same manner as described above, and may be performed intermittently or continuously after the step of bringing at least a portion of a poultry carcass into contact with the hypobromous acid-containing water.

In another embodiment, a method of treating at least a portion of a poultry carcass in a reservoir during processing for increasing the weight of the poultry utilizes hypobromous acid. The method comprises:
(a) Providing, in a reservoir, a hypobromous acid-containing water having a pH of about 6.5 to about 10, wherein the hypobromous acid-containing water comprises water and an antimicrobial amount of an aqueous solution of hypobromous acid, and wherein the hypobromous acid-containing water has a temperature.

The solution of hypobromous acid may be prepared by mixing an aqueous solution of hydrogen bromide and a source of hypochlorite with water. Appropriate sources of hypochlorite include a solution of sodium hypochlorite, a solution of potassium hypochlorite, solid calcium hypochlorite, and solid lithium hypochlorite. Preferably, the aqueous hydrogen bromide and the source of hypochlorite are mixed in a mole ratio of about 1 to about 1 to form a solution of hypobromous acid containing about 50 to about 30,000 ppm as Br₂.

The hypobromous acid-containing water is provided in a reservoir. The reservoir may be any type of container suitable for cooling poultry during processing, such as a chill tank or other vessel. This may be accomplished in several ways. One way is to separately introduce the water and the hypobromous acid solution into the reservoir. The hypobromous acid solution may be added to the reservoir simultaneously with the water or it may be added after the reservoir is filled with the water. Any means of introducing a liquid product to water can be used, such as a diaphragm pump, peristaltic pump, or a vacuum eductor to introduce the hypobromous acid solution into the reservoir water. Another way is to combine the water and the hypobromous acid solution outside the reservoir to form hypobromous acid-containing water and then introduce the hypobromous acid-containing water into the reservoir.

An antimicrobial amount of hypobromous acid is used. The amount is sufficient to prevent cross-contamination of bacteria between the poultry carcasses and to eradicate or reduce any pathogenic or spoilage microorganisms still resident on the carcasses. The amount of hypobromous acid that is used depends on the microbiological condition of the carcasses, but should be sufficient to provide about 1 ppm to about 99 ppm as Br₂ in the hypobromous acid-containing water. Any suitable method of analyzing the amount of hypobromous acid in the water can be used. These methods include test strips which change color depending on the amount hypobromous acid present, and the analytical methods described above in Experimental Methods.

The pH of the hypobromous acid-containing water that is formed is about 6.5 to about 10.

The hypobromous acid-containing water is preferably recirculated. A pump is used to recirculate the water through the reservoir, then through an external refrigeration unit where it is chilled, and then back to the reservoir. To maximize the efficiency of cooling the carcasses, the flow of chilled water should be opposite to the direction of movement of the carcasses through the reservoir.

The hypobromous acid-containing water is chilled to a temperature that is lower than the temperature of the carcasses just before they are placed into the reservoir and is maintained at this temperature. A preferable temperature is about 33-34° F. This may be accomplished by chilling the hypobromous acid-containing water in an external refrigeration unit during recirculation, chilling the water before the hypobromous acid solution is added to the water, or other methods.
(b) Placing into the hypobromous acid-containing water at least a portion of a poultry carcass having a first weight and having a first temperature greater than the temperature of the hypobromous acid-containing water.

A poultry carcass is placed into the hypobromous acid-containing water in the reservoir. Before it is placed into the reservoir, the poultry carcass has a specific weight referred to as a first weight, and has a specific temperature referred to as a first temperature. The first temperature is greater than the temperature of the hypobromous acid-containing water in the reservoir.

The carcasses may be rotated in the reservoir on an auger or may be turned or stirred by any other suitable method that will allow at least a portion of a carcass to come into contact with the hypobromous acid-containing water.

At any time after the poultry carcasses are placed into hypobromous acid-containing water, up to about ½ gallon of the hypobromous acid-containing water may be removed or bled off from the reservoir for each poultry carcass that enters the reservoir in order to keep the level of contaminants, such as blood, fecal matter, and ingesta, in the hypobromous acid-containing water at an acceptable level. Additional water (make-up water) is introduced into the reservoir to maintain the volume of water in the reservoir, and additional hypobromous acid is introduced into the reservoir as needed to keep the amount of hypobromous acid at about 1 ppm to about 99 ppm to continue to provide sufficient antimicrobial efficacy. The make-up water and the hypobromous acid may be introduced separately into the reservoir or they may be combined outside the reservoir to form hypobromous acid-containing water which is then introduced into the reservoir. The amount of hypobromous acid that will need to be added and the frequency of addition depend on the number of carcasses in the reservoir and the microbial condition of the carcasses. Any suitable method of analyzing the amount of hypobromous acid in the water can be used, including the methods described in step (a) above. The bleeding off of the hypobromous acid-containing water may be repeated or may be performed continuously. The hypobromous acid-containing water that is bled off may be reused in any processing step that is upstream from (earlier than) the reservoir from which it is removed.
(c) Allowing the hypobromous acid-containing water having the pH of about 6.5 to about 10 to increase the first weight of at least the portion of the poultry carcass to a second weight greater than the first weight to provide an increased weight of at least the portion of the poultry carcass and to lower the first temperature of at least the portion of the poultry carcass to a second temperature less than the first temperature for cooling at least the portion of the poultry carcass.

The poultry carcasses are left in the hypobromous acid-containing water in the reservoir until they are cooled to a second temperature, preferably about 33-34° F. The amount of time required for cooling depends on the number of carcasses in the reservoir, the size of the carcasses, and other factors. Typically, chickens are left in a chill tank for about 30-45 minutes, while turkeys are left longer, for up to about three hours. While the poultry carcasses are in the hypobromous acid-containing water in the reservoir, the weight of the poultry carcasses increases to a second weight which is greater than the first weight.
(d) Removing at least the portion of the poultry carcass having the increased weight from the hypobromous acid-containing water.

The poultry carcasses are removed from the hypobromous acid-containing water. Each poultry carcass has an increased weight because the second weight, which is the weight of a carcass after removal from the hypobromous acid-containing water, is greater than the first weight, which is the weight of a carcass before being placed into the hypobromous acid-containing water.

Optionally, before the step of placing at least the portion of the poultry carcass into the hypobromous acid-containing water, a step of determining the pH of the hypobromous acid-containing water and a subsequent step of altering the pH may be performed. The pH of the hypobromous acid-containing water is determined by any method, including the use of a glass electrode, indicator solutions, and pH test strips. If the pH is determined to be about 6.5 to about 10, then no pH-altering step is performed and the step of placing at least the portion of the poultry carcass into the hypobromous acid-containing water is performed next. If the pH is determined to be lower than about 6.5 or higher than about 10, then a subsequent pH-altering step is performed. If the pH is determined to be lower than about 6.5, then a source of alkali is added to the hypobromous acid-containing water to raise the pH of the hypobromous acid-containing water to about 6.5 to about 10. Any suitable source of alkali may be used. Examples include, but are not limited to, alkali metal or earth alkali metal carbonates, bicarbonates, oxides, and hydroxides. When solutions are preferred, sodium hydroxide or potassium hydroxide solutions are convenient to use, alone or in combination with each other. A preferred alkaline source is 50% NaOH solution. To prevent crystallization problems upon storage in cold climates, the 50% NaOH solution may be diluted with water and then used. If the pH is determined to be higher than about 10, then a source of acid is added to the hypobromous acid-containing water to lower the pH of the hypobromous acid-containing water to about 6.5 to about 10. Any suitable source of acid may be used. Inorganic acids are preferred because they are less expensive than organic acids and possess higher pH-lowering properties. Suitable inorganic acids include solutions of sulfuric acid, hydrochloric acid, phosphoric acid, nitric acid, and sodium hydrogen sulfate. Preferable inorganic acids are phosphoric acid and sodium hydrogen sulfate because they are FDA-approved for food contact purposes. Organic acids may be used, and include citric acid and lactic acid, which are FDA-approved. After altering the pH, the step of placing at least a portion of a poultry carcass into the hypobromous acid-containing water is performed next.

Also, optionally, after the step of placing at least a portion of a poultry carcass into the hypobromous acid-containing water, a step of determining the pH of the hypobromous acid-containing water and a subsequent step of altering the pH may be performed. This pH-determining and pH-altering step is performed in the same manner as described above, and may be performed intermittently or continuously after the step of placing at least a portion of a poultry carcass into the hypobromous acid-containing water.

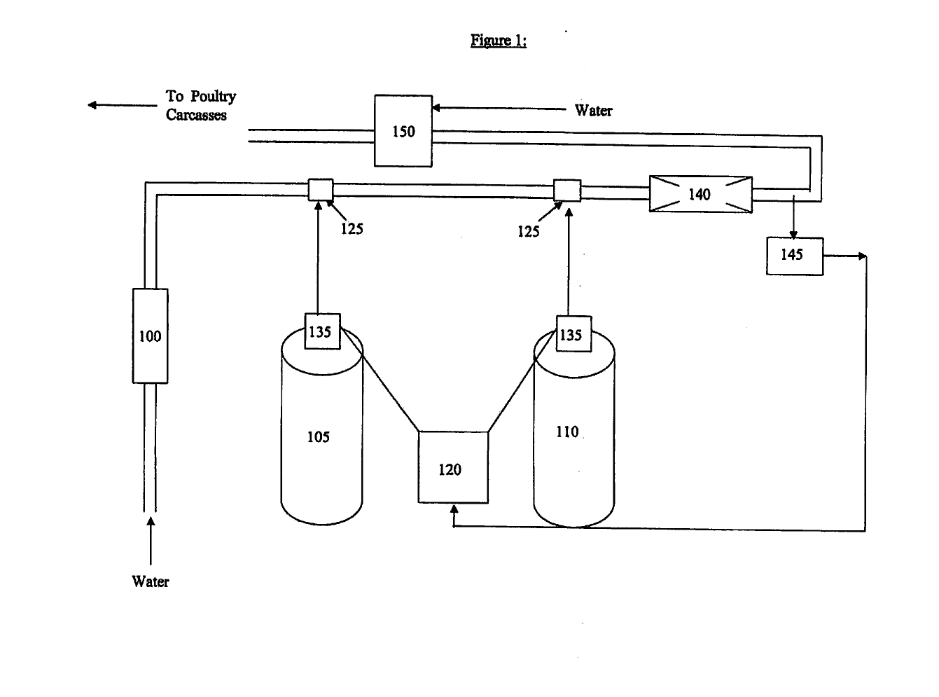

FIG. 1 is a schematic representation of an example of a system used in an embodiment of one of the methods to continuously or intermittently prepare a solution of hypobromous acid using aqueous hydrogen bromide for use in a poultry chill tank. A container of aqueous hydrogen bromide solution 105 and a container of a source of hypochlorite, preferably sodium hypochlorite bleach, 110 were each equipped with chemical delivery diaphragm pumps 135. Water was directed through a flowmeter 100 and into a length of pipe where the hydrogen bromide solution was introduced through injection point 125, and sodium hypochlorite solution was introduced through injection point 130. The hydrogen bromide solution and the sodium hypochlorite solution may be added in a sequential manner with either solution first, or they may be added to the water simultaneously through a Tee fitting. In this case, the hydrogen bromide solution and the sodium hypochlorite solution are introduced to the two arms of a Tee fitting and the mixture is injected into the pipe of water. Because the dilution water flow is typically controlled by a solenoid or valve, this method of addition can be either continuous or intermittent depending upon the position of the flow control valve. The water containing hydrogen bromide and sodium hypochlorite solutions was mixed using an in-line static mixer 140. A pH probe and meter 145 monitored the pH of the mixture and adjusted the rate of addition of hydrogen bromide solution or sodium hypochlorite solution through a pH controller 120 that is interfaced to the chemical delivery diaphragm pumps 135. The mixture was then directed to a proportional dispenser 150 set to dilute the mixture to the desired hypobromous acid concentration with water. The degree of dilution depends on the required concentration of hypobromous acid. Instead of proportional dispenser 150 a conventional diaphragm or centrifugal pump may be used to effect the desired dilution provided the volumetric flows rates of the dilution water and activated solution are known.

### EXAMPLES

### Examples 1-3

The apparatus represented in FIG. 1 was used to continuously generate solutions of hypobromous acid that were close to 300 ppm (as Br₂). The results are shown in Table I, which includes the reference numerals used in FIG. 1.

TABLE I
Flow Rates and Dilution Ratios

| | | | | Br₂ | | |
|---|---|---|---|---|---|---|
| | Water flow | 24% HBr | | concentration | | |
| | through | flow | 12.5% NaOCl | entering | Dilution | |
| | flowmeter | through | through pump | proportional | ratio at | Final Br₂ |
| Example | 100 | pump 35 | 35 | dispenser 150 | proportional | concentration |
| No. | /l/min | /ml/min | /ml/min | /ppm | dispenser 150 | /ppm |
| 1 | 3.785 | 38.4 | 68.9 | 5865 | 19.6 | 300 |
| 2 | 3.785 | 52.5 | 94.7 | 8050 | 26.8 | 300 |
| 3 | 1.0 | 0.525 | 0.991 | 289 | N/A | 289 |

### Example 4

This example shows that treating poultry carcasses in chilled hypobromous acid-containing water (100 ppm as bromine) having a pH of 6.5, 8.25 or 10, prepared by combining aqueous hydrogen bromide and sodium hypochlorite, provided an increase in weight of the poultry carcasses in addition to providing antibacterial benefits.

Thirty freshly killed chickens that had been picked (defeathered) and eviscerated were removed from a processing line at a poultry processing plant before they entered the plant's chicken chill tank. Each chicken was cut evenly into two halves after the removal of internal organs and thoroughly rinsed. This resulted in a total of 60 chicken halves which were still warm from body temperature.

Three 30-gallon bins, labeled Bin 1 (pH 6.5), Bin 2 (pH 8.25), and Bin 3 (pH 10), were filled with a combination of ice and soft water (20 L) which was enough volume to submerge 20 chicken halves at each pH. The temperature of the water in the bins was 42° F., simulating a poultry chill tank. The temperature of the water was monitored and kept constant using frozen bottles of water as ice packs.

Salmonella typhimurium bacteria (ATCC 14028) were cultured in nutrient broth (Sigma, St. Louis, Mo.) by incubation for two days at 35° C. The bacteria were separated from the nutrient broth by centrifugation and carefully resuspended in approximately 500 mL of sterile phosphate buffer, which was later used to inoculate the chilled water. The amount of the Salmonella typhimurium was measured in the Salmonella inoculum by plating using 3M Petrifilm Enterobacteriaceae plates and incubated at 35° C. for 24 hours, upon which the plates were enumerated. The amount of Salmonella typhimurium in the inoculum was 2.19×10⁸ CFU/mL (log₁₀ 8.34).

The three bins were inoculated with Salmonella typhimurium inoculum (166.5 g) and mixed manually. The amount of the Salmonella typhimurium was measured in the Salmonella inoculated water by plating and enumerating as described for the inoculum. The chicken halves were then placed into the three 30 gallon respective bins, pH 6.5, 8.25, and 10, before the hypobromous acid was introduced.

Hypobromous acid was prepared by combining aqueous hydrogen bromide and sodium hypochlorite in a mole ratio of about 1 to about 1. A solution of 24% hydrogen bromide (4.8 mL) was mixed with a solution of 13.1% sodium hypochlorite (10 mL) in soft water (850 g). The hypobromous acid had a concentration of 2768 ppm as Br₂. The hypobromous acid solution was then used to dose the three bins to a nominal 100 ppm as Br₂, by introducing the hypobromous acid to the chilled water of each bin and manually mixing with a plastic rod to form hypobromous acid-containing water. The amount of hypobromous acid solution introduced to each bin was 722.5 g. The initial concentrations of hypobromous acid (as Br₂), measured using the modified DPD method, were 77.5 ppm, 81.0 ppm, and 85.5 ppm, for Bin 1, Bin 2, and Bin 3, respectively. The pHs of the hypobromous acid-containing water with the chickens before altering were measured to be 7.4, 7.3, and 7.5, for Bin 1, Bin 2, and Bin 3, respectively. The target pHs for the bins were 6.5, 8.25, and 10, for Bin 1, Bin 2, and Bin 3, respectively. The pHs of Bin 1, Bin 2, and Bin 3 were altered to 6.40 (with 37% hydrochloric acid), 8.34 (with 50% sodium hydroxide), and 10.50 (with 50% sodium hydroxide), respectively.

Twenty chicken halves and several frozen bottles of water were placed in each of the three bins and were allowed to sit in the chilled solution for three hours. The chicken halves were periodically manually turned over in the water to simulate their movement through a poultry chill tank. The amount of the Salmonella typhimurium remaining was measured at 0 minutes, 10 minutes, 1 hour, 2 hours, and 3 hours after placement of the chicken halves in the bins, by removing an aliquot of the chilled water followed by serial dilution (except for the zero dilution) and plating and enumerating as previously described. After 3 hours, the final concentrations of hypobromous acid (as Br₂), measured using the modified DPD method, were 0.11 ppm, 0.43 ppm, and 0.34 ppm, for Bin 1, Bin 2, and Bin 3, respectively, and the final pHs were 6.62, 8.04, and 9.55, respectively.

After three hours, the chicken halves were removed, shaken 10 times to remove excess water, and then weighed. Because the chicken halves had been identified by individual tags, the difference between the initial weight and the weight after three hours in the chilled water was measured for each chicken half, and the difference was used to determine the weight gain and the percentage weight gain for each half. Then, using this difference for each of the 20 chicken halves, the average weight gain and the average percentage weight gain were calculated, along with determining the differences in the weight gained at the three different pHs.

Table II summarizes the results. The standard errors for each set of data are also shown.

TABLE II

| | Bin 1 (pH 6.5) | Bin 2 (pH 8.25) | Bin 3 (pH 10) |
|---|---|---|---|
| # Chicken Halves | 20 | 20 | 20 |
| Avg. Weight of | 787.29 | 781.70 | 743.68 |
| Chicken Half | | | |
| Before Chill/g | | | |
| Avg. Weight of | 827.32 | 847.85 | 815.79 |
| Chicken Half | | | |
| After Chill/g | | | |
| Avg. Weight Gain/g | 40.03 | 66.15 | 72.11 |
| Average | 5.29 | 8.59 | 9.69 |
| % Weight Gain | | | |
| Standard Error | 0.3984 | 0.5659 | 0.5044 |
| ±% | | | |

Table III summarizes the efficacy data for the three bins, and shows the results for the pre-treated inoculated water, immediately after administering the hypobromous acid, ten minutes, one hour, two hours, and three hours after administering the hypobromous acid (termination of the study).

TABLE III

| | Theoretical | | log₁₀ | log₁₀ | % |
|---|---|---|---|---|---|
| Bin | pH | Description | Remaining | Reduction | Reduction |
| Bin 1 | 6.5 | Pre-Treated | 6.06 | N/A | N/A |
| | | 0 min | 2.70 | 3.36 | 99.96 |
| | | 10 min | 1.79 | 4.27 | 99.995 |
| | | 1 hr | 1.23 | 4.83 | 99.999 |
| | | 2 hr | 2.57 | 3.49 | 99.97 |
| | | 3 hr | 3.20 | 2.86 | 99.86 |
| Bin 2 | 8.25 | Pre-Treated | 6.56 | N/A | N/A |
| | | 0 min | 1.53 | 5.03 | 99.9991 |
| | | 10 min | 0.90 | 5.66 | 99.9998 |
| | | 1 hr | 2.10 | 4.46 | 99.997 |
| | | 2 hr | 3.51 | 3.05 | 99.91 |
| | | 3 hr | 3.70 | 2.86 | 99.86 |
| Bin 3 | 10 | Pre-Treated | 5.62 | N/A | N/A |
| | | 0 min | 2.76 | 2.86 | 99.86 |
| | | 10 min | 0.78 | 4.84 | 99.9986 |
| | | 1 hr | 1.30 | 4.32 | 99.995 |
| | | 2 hr | 0.95 | 4.67 | 99.998 |
| | | 3 hr | 2.60 | 3.02 | 99.90 |

Table III shows that the high level of approximately 100 ppm Br₂ from hypobromous acid was effective at reducing the level of Salmonella typhimurium at pH 6.5, 8.25, and 10, immediately after the initial dose, at ten minutes, one hour, two hours, and three hours.

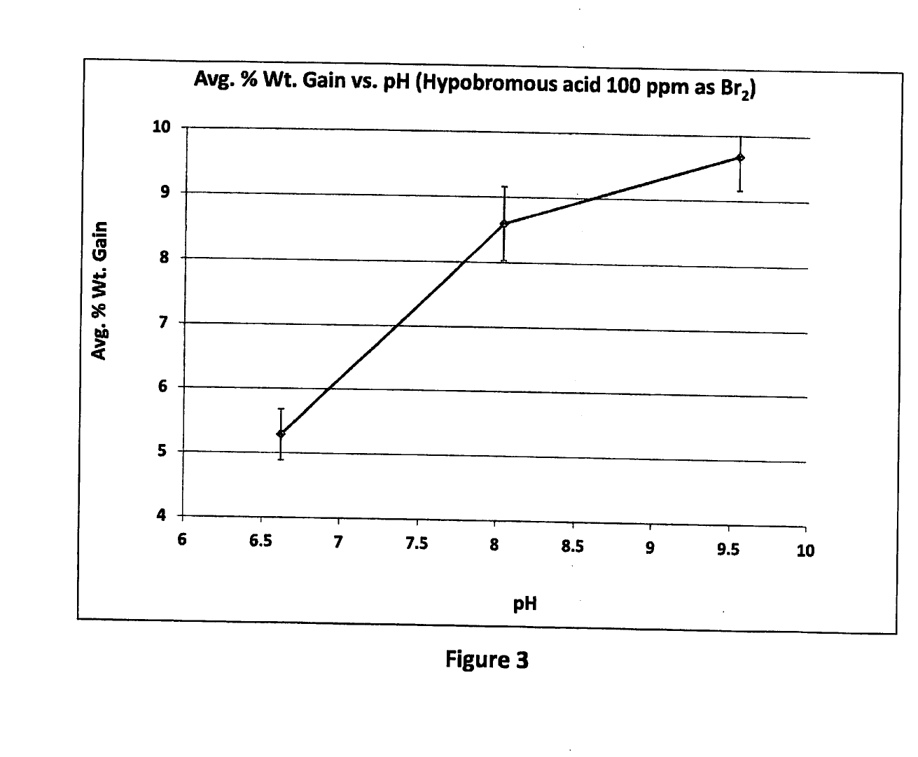

FIG. 3 shows the average percent weight gain of the chicken halves versus pH. The squares represent the average percent weight gain. The error bars represent the standard error, also referred to as the standard deviation of the average.

The statistical analysis was performed using the “Two Sample Assuming Un-Equal Variances” t-test (Analysis ToolPak, Microsoft Excel, 2007).

The t-test results are displayed in Tables IV, V, and VI. The t-test calculated the average percent weight gained by the chicken halves for each data set, the variance, number of replicates, degrees of freedom (df), t-stat value, and the P two-tail value.

The P (two-tail)-value refers to the confidence level calculated by the t-test. It provides the level of confidence that the averages of the percent weight gain of chicken halves soaked in hypobromous acid-containing water at the different pHs are statistically different and not just chance findings.

Table IV displays the t-test results when Bin 2 (pH 8.25) was compared to Bin 1 (pH 6.5).

TABLE IV
t-Test: Two-Sample Assuming Unequal Variances

| | 100 ppm Br₂ | 100 ppm Br₂ |
|---|---|---|
| | (pH 8.25) | (pH 6.5) |
| Mean | 8.594509 | 5.286144 |
| Variance | 6.404044 | 3.174882 |
| Observations | 20 | 20 |
| df | 34 | |
| t Stat | 4.780464 | |
| P(T <= t) two-tail | 3.3E−05 | |
| t Critical two-tail | 2.032244 | |

Using a t-table, the confidence level was approximated. The t-value (4.78) exceeded the 99.9% confidence levels with a t-stat value of 2.03. To determine the exact confidence level, the P-value was used in the determination (100%−0.003%), thus, the confidence level is established at 99.997% that the average percent weight gain of chicken halves soaked in hypobromous acid-containing water at pH 6.5 and pH 8.25 are statistically different.

Table V displays the t-test results when Bin 3 (pH 10) was compared to Bin 1 (6.25).

TABLE V
t-Test: Two-Sample Assuming Unequal Variances

| | | 100 ppm Br₂ |
|---|---|---|
| | 100 ppm Br₂ (pH 10) | (pH 6.5) |
| Mean | 9.686696678 | 5.286144 |
| Variance | 5.088789253 | 3.174882 |
| Observations | 20 | 20 |
| df | 36 | |
| t Stat | 6.845981588 | |
| P(T <= t) two-tail | 5.23199E−08 | |
| t Critical two-tail | 2.028093987 | |

Using a t-table, the confidence level was approximated. The t-value (6.85) exceeded the 99.9% confidence levels with a t-stat value of 2.03. To determine the exact confidence level, the P-value was used in the determination (100%−0.000006%), thus, the confidence level is established at 99.999995% that the average percent weight gain of chicken halves soaked in hypobromous acid-containing water at pH 6.5 and pH 10 are statistically different.

Table VI displays the t-test results when Bin 3 (pH 10) was compared to Bin 2 (pH 8.25).

TABLE VI
t-Test: Two-Sample Assuming Unequal Variances

| | | 100 ppm Br₂ |
|---|---|---|
| | 100 ppm Br₂ (pH 10) | (pH 8.25) |
| Mean | 9.686696678 | 8.594509 |
| Variance | 5.088789253 | 6.404044 |
| Observations | 20 | 20 |
| df | 38 | |
| t Stat | 1.440783001 | |
| P(T <= t) two-tail | 0.157835638 | |
| t Critical two-tail | 2.024394147 | |

Using a t-table, the confidence level was approximated. The t-value (1.44) was bracketed between confidence levels 80.0% with a t-stat value of 1.30 and 90.0% with a t-stat value of 1.689. Thus, the confidence level is established at 84.22% that the average percent weight gain of chicken halves soaked in hypobromous acid-containing water at pH 8.25 and pH 10 are statistically different.

### Example 5

This example shows that treating poultry carcasses in chilled hypobromous acid-containing water (1 ppm as bromine) having a pH of 6.5, 8.25 or 10, prepared by combining aqueous hydrogen bromide and sodium hypochlorite, provided an increase in weight of the poultry carcasses in addition to providing antibacterial benefits.

Thirty freshly killed chickens that had been picked (defeathered) and eviscerated were removed from a processing line at a poultry processing plant before they entered the plant's chicken chill tank. The chickens, which were still warm from body temperature, were prepared and weighed as described in Example 4.

Three 30-gallon bins, labeled Bin 1 (pH 6.25), Bin 2 (pH 8.25), and Bin 3 (pH 10), were filled with a combination of ice and soft water (20 L) which was enough volume to submerge 20 chicken halves at each pH. The temperature of the water in the bins was 42° F., simulating a poultry chill tank. The temperature of the water was monitored and kept constant using frozen bottles of water as ice packs.

The Salmonella typhimurium inoculum was prepared as described in Example 4. The amount of the Salmonella typhimurium was measured in the Salmonella inoculum by plating using 3M Petrifilm Enterobacteriaceae plates and incubated at 35° C. for 24 hours, upon which the plates were enumerated. The amount of Salmonella typhimurium in the inoculum was 1.05×10⁸ CFU/mL (log₁₀ 8.02).

The three bins were inoculated with Salmonella typhimurium inoculum (166.5 g) and mixed manually. The amount of the Salmonella typhimurium was measured in the Salmonella inoculated water by plating and enumerating as described for the inoculum. The chicken halves were then placed into the three respective bins, pH 6.5, 8.25, and 10, before the hypobromous acid was introduced.

The hypobromous acid was prepared by combining aqueous hydrogen bromide and sodium hypochlorite in a mole ratio of about 1 to about 1. A solution of 24% hydrogen bromide (4.8 mL) was mixed with a solution of 13.1% sodium hypochlorite (10 mL) in soft water (850 g). The hypobromous acid had a concentration of 2902 ppm as Br₂. The hypobromous acid solution was then used to dose the three bins to a nominal 1 ppm as Br₂, by introducing the hypobromous acid to the chilled water of each bin and manually mixing with a plastic rod to form hypobromous acid-containing water. The amount of hypobromous acid solution introduced to each bin was 7.0 g. The initial concentrations of hypobromous acid (as Br₂), measured using the modified DPD method, were 0.50 ppm, 0.85 ppm, and 0.95 ppm, for Bin 1, Bin 2, and Bin 3, respectively. The pHs of the hypobromous acid-containing water with the chickens before altering were measured to be 7.4, 7.5, and 7.4, for Bin 1, Bin 2, and Bin 3, respectively. The target pHs for the bins were 6.5, 8.25, and 10, for Bin 1, Bin 2, and Bin 3, respectively. The pHs of Bin 1, Bin 2, and Bin 3 were altered to 6.59 (with 37% hydrochloric acid), 8.10 (with 50% sodium hydroxide), and 10.10 (with 50% sodium hydroxide), respectively.

The chicken halves were soaked as described in Example 4. The amount of the Salmonella typhimurium remaining was measured at 0 minutes, 10 minutes, 1 hour, 2 hours, and 3 hours after placement of the chicken halves in the bins, by removing an aliquot of the chilled water followed by serial dilution (except for the zero dilution) and plating and enumerating as previously described. A calculated amount of hypobromous acid was added to the bins to keep the concentration at a nominal 1 ppm as Br₂. After 3 hours, the final concentrations of hypobromous acid (as Br₂), measured using the modified DPD method, were 1.11 ppm, 0.95 ppm, and 0.79 ppm, for Bin 1, Bin 2, and Bin 3, respectively, and the final pHs were 6.42, 8.30, and 9.97, respectively.

After three hours, each chicken half was removed for weighing as described in Example 4.

Table VII summarizes the results. The standard errors for each set of data are also shown.

TABLE VII

| | Bin 1 | Bin 2 | Bin 3 |
|---|---|---|---|
| | (pH 6.5) | (pH 8.25) | (pH 10) |
| # Chicken Halves | 20 | 20 | 20 |
| Avg. Weight of | 798.93 | 724.50 | 757.01 |
| Chicken Half | | | |
| Before Chill/g | | | |
| Avg. Weight of | 877.53 | 825.27 | 868.38 |
| Chicken Half | | | |
| After Chill/g | | | |
| Avg. Weight Gain/g | 78.60 | 100.77 | 111.37 |
| Average | 9.73 | 14.02 | 14.83 |
| % Weight Gain | | | |
| Standard | 0.442 | 0.623 | 0.542 |
| Error ± % | | | |

Table VIII summarizes the efficacy data for the three bins, and shows the results for the pre-treated inoculated water, immediately after administering the hypobromous acid, ten minutes, one hour, two hours, and three hours after administering the hypobromous acid (termination of the study).

TABLE VIII

| | Theoretical | | log₁₀ | log₁₀ | % |
|---|---|---|---|---|---|
| Bin | pH | Description | Remaining | Reduction | Reduction |
| Bin 1 | 6.5 | Pre-Treated | 4.00 | N/A | N/A |

| | | | | |
|---|---|---|---|---|
| 0 | min | 3.32 | 0.68 | 79.11 |
| 10 | min | 3.27 | 0.73 | 81.38 |
| 1 | hr | 2.87 | 1.13 | 92.59 |
| 2 | hr | 2.36 | 1.64 | 97.97 |
| 3 | hr | 1.85 | 2.15 | 99.29 |

| | | | | | |
|---|---|---|---|---|---|
| Bin 2 | 8.25 | Pre-Treated | 3.54 | N/A | N/A |

| | | | | |
|---|---|---|---|---|
| 0 | min | 3.48 | 0.06 | 12.91 |
| 10 | min | 3.76 | 0.00 | 0.00 |
| 1 | hr | 3.90 | 0.00 | 0.00 |
| 2 | hr | 2.68 | 0.86 | 86.20 |
| 3 | hr | 2.40 | 1.14 | 92.76 |

| | | | | | |
|---|---|---|---|---|---|
| Bin 3 | 10 | Pre-Treated | 3.77 | N/A | N/A |

| | | | | |
|---|---|---|---|---|
| 0 | min | 3.15 | 0.62 | 76.00 |
| 10 | min | 3.53 | 0.24 | 42.46 |
| 1 | hr | 3.26 | 0.51 | 69.09 |
| 2 | hr | 2.45 | 1.32 | 95.21 |
| 3 | hr | 2.49 | 1.28 | 94.75 |

Table VIII shows that the low level of approximately 1 ppm Br₂ from hypobromous acid was relatively effective at reducing the level of Salmonella typhimurium at pH 6.5, 8.25, and 10, immediately after the initial dose, at ten minutes, one hour, two hours, and three hours.

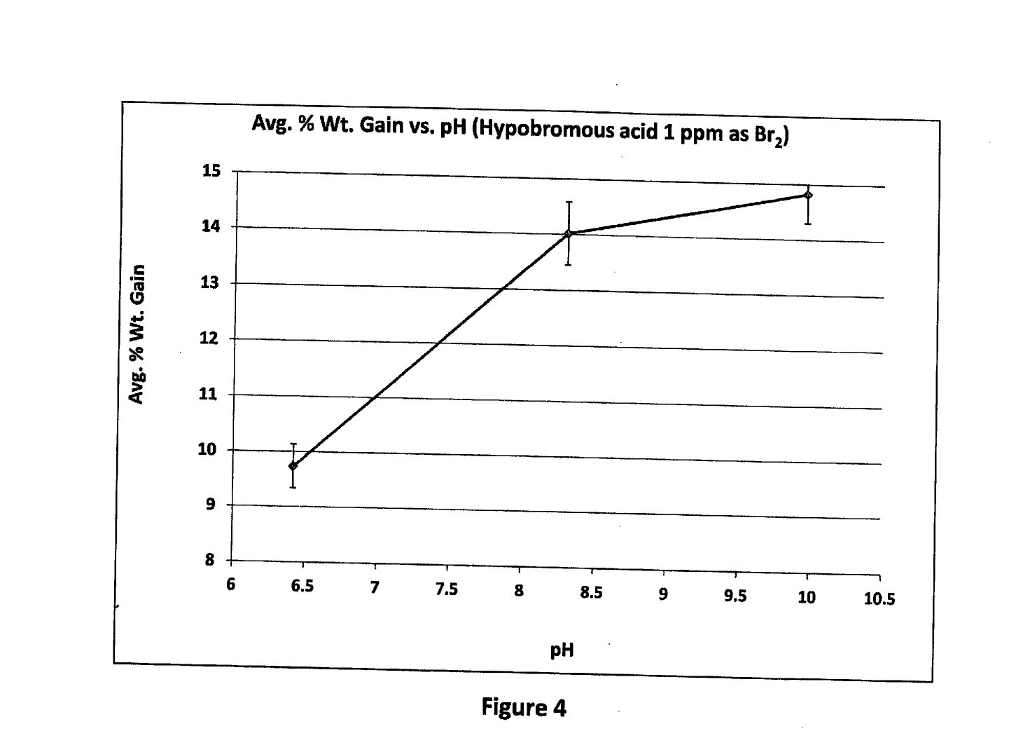

FIG. 4 shows the average percent weight gain of the chicken halves versus pH. The squares represent the average percent weight gain. The error bars represent the standard error, also referred to as the standard deviation of the average.

The statistical analysis was performed using the “Two Sample Assuming Un-Equal Variances” t-test (Analysis ToolPak, Microsoft Excel, 2007).

The t-test results are displayed in Tables IX, X, and XI. The t-test calculated the average percent weight gained by the chicken halves for each data set, the variance, number of replicates, degrees of freedom (df), t-stat value, and the P two-tail value.

The P (two-tail)-value refers to the confidence level calculated by the t-test. It provides the level of confidence that the averages of the percent weight gain of chicken halves soaked in hypobromous acid-containing water at the different pHs are statistically different and not just chance findings.

Table IX displays the t-test results when Bin 2 (pH 8.25) was compared to Bin 1 (pH 6.5).

TABLE IX
t-Test: Two-Sample Assuming Unequal Variances

| | 1 ppm Br₂ | 1 ppm Br₂ |
|---|---|---|
| | (pH 8.25) | (pH 6.5) |
| Mean | 14.01707911 | 9.733015709 |
| Variance | 7.769957532 | 3.906729769 |
| Observations | 20 | 20 |
| df | 34 | |
| t Stat | 5.606748331 | |
| P(T <= t) two-tail | 2.79428E−06 | |
| t Critical two-tail | 2.032244498 | |

Using a t-table, the confidence level was approximated. The t-value (5.61) exceeded the 99.9% confidence levels with a t-stat value of 2.03. To determine the exact confidence level, the P-value was used in the determination (100%−0.0003%), thus, the confidence level is established at 99.9997% that the average percent weight gain of chicken halves soaked in hypobromous acid-containing water at pH 6.5 and pH 8.25 are statistically different.

Table X displays the t-test results when Bin 3 (pH 10) was compared to Bin 1 (6.25).

TABLE X
t-Test: Two-Sample Assuming Unequal Variances

| | 1 ppm Br₂ | 1 ppm Br₂ |
|---|---|---|
| | (pH 10) | (pH 6.5) |
| Mean | 14.82771162 | 9.733015709 |
| Variance | 5.867281689 | 3.906729769 |
| Observations | 20 | 20 |
| df | 37 | |
| t Stat | 7.287806666 | |
| P(T <= t) two-tail | 1.17622E−08 | |
| t Critical two-tail | 2.026192447 | |

Using a t-table, the confidence level was approximated. The t-value (7.29) exceeded the 99.9% confidence levels with a t-stat value of 2.03. To determine the exact confidence level, the P-value was used in the determination (100%−0.000007%), thus, the confidence level is established at 99.999993% that the average percent weight gain of chicken halves soaked in hypobromous acid-containing water at pH 6.5 and pH 10 are statistically different.

Table XI displays the t-test results when Bin 3 (pH 10) was compared to Bin 2 (pH 8.25).

TABLE XI
t-Test: Two-Sample Assuming Unequal Variances

| | 1 ppm Br₂ | 1 ppm Br₂ |
|---|---|---|
| | (pH 10) | (pH 8.25) |
| Mean | 14.82771162 | 14.01707911 |
| Variance | 5.867281689 | 7.769957532 |
| Observations | 20 | 20 |
| df | 37 | |
| t Stat | 0.981693201 | |
| P(T <= t) two-tail | 0.332626938 | |
| t Critical two-tail | 2.026192447 | |

Using a t-table, the confidence level was approximated. The t-value (0.98) was bracketed between confidence levels 60.0% with a t-stat value of 0.85 and 70.0% with a t-stat value of 1.05. Thus, the confidence level is established at 66.74% that the average percent weight gain of chicken halves soaked in hypobromous acid-containing water at pH 8.25 and pH 10 are statistically different.

B. Methods Utilizing Sodium Bromide

In an embodiment, a method of treating at least a portion of a poultry carcass for increasing the weight of the poultry utilizes hypobromous acid. The method comprises:
(a) Combining water and an antimicrobial amount of an aqueous solution of hypobromous acid for forming hypobromous acid-containing water having a pH of about 6.5 to about 10.

The hypobromous acid solution may be prepared by mixing an aqueous solution of sodium bromide and a source of hypochlorite. Appropriate sources of hypochlorite include a solution of sodium hypochlorite, a solution of potassium hypochlorite, solid calcium hypochlorite, and solid lithium hypochlorite. Preferably, the aqueous sodium bromide and the source of hypochlorite are mixed in a mole ratio of about 1 to about 1 to form a solution of hypobromous acid containing about 880 to about 197,200 ppm as Br₂.

A mineral acid may be added to lower the pH in order to accelerate the reaction of the sodium bromide mixture with the source of hypochlorite. Preferably, the mole ratio of the amount of protons introduced by the mineral acid to the amount of sodium bromide added is about 1 to about 1. Most preferably, the mole ratio of protons from the mineral acid to sodium bromide to the sodium hypochlorite solution is about 1 to about 1 to about 1. Suitable mineral acids include sulfuric, hydrochloric, nitric, and phosphoric acid. The acid may be introduced to the mixture by premixing it with the aqueous sodium bromide first, before introducing it to the source of hypochlorite; it may be added first, before the aqueous sodium bromide is introduced to the source of hypochlorite; it may be added after the introduction of the source of hypochlorite; or it may be added at the same time as the aqueous sodium bromide and the source of hypochlorite.

The water, which may be softened, and the hypobromous acid solution are combined to form hypobromous acid-containing water. An antimicrobial amount of hypobromous acid is used. The amount is sufficient to prevent cross-contamination of bacteria between the poultry carcasses and to eradicate or reduce any pathogenic or spoilage microorganisms still resident on the carcasses. The amount of hypobromous acid that is used depends on the microbiological condition of the carcasses, but should be sufficient to provide about 1 ppm to about 99 ppm as Br₂ in the hypobromous acid-containing water. Any suitable method of analyzing the amount of hypobromous acid in the water can be used. These methods include test strips which change color depending on the amount hypobromous acid present, and the analytical methods described above in Experimental Methods.

The pH of the hypobromous acid-containing water that is formed is about 6.5 to about 10.
(b) Bringing at least a portion of a poultry carcass into contact with the hypobromous acid-containing water for increasing the weight of at least the portion of the poultry carcass from a first weight prior to contact with the hypobromous acid-containing water to a second weight greater than the first weight after contact with the hypobromous acid-containing water.

A portion of a poultry carcass is brought into contact with the hypobromous acid-containing water. This may be accomplished by placing the carcass in a reservoir with the hypobromous acid-containing water, or by other methods, such as by passing the carcass through the hypobromous acid-containing water. Before it is brought into contact with the hypobromous acid-containing water, the poultry carcass has a specific weight, referred to as a first weight. After contact with the hypobromous acid-containing water, the poultry carcass has a specific weight, referred to as a second weight, which is greater than the first weight.

Optionally, before the step of bringing at least the portion of the poultry carcass into contact with the hypobromous acid-containing water, a step of determining the pH of the hypobromous acid-containing water and a subsequent step of altering the pH may be performed. The pH of the hypobromous acid-containing water is determined by any method, including the use of a glass electrode, indicator solutions, and pH test strips. If the pH is determined to be about 6.5 to about 10, then no pH-altering step is performed and the step of bringing at least the portion of the poultry carcass into contact with the hypobromous acid-containing water is performed next. If the pH is determined to be lower than about 6.5 or higher than about 10, then a subsequent pH-altering step is performed. If the pH is determined to be lower than about 6.5, then a source of alkali is added to the hypobromous acid-containing water to raise the pH of the hypobromous acid-containing water to about 6.5 to about 10. Any suitable source of alkali may be used. Examples include, but are not limited to, alkali metal or earth alkali metal carbonates, bicarbonates, oxides, and hydroxides. When solutions are preferred, sodium hydroxide or potassium hydroxide solutions are convenient to use, alone or in combination with each other. A preferred alkaline source is 50% NaOH solution. To prevent crystallization problems upon storage in cold climates, the 50% NaOH solution may be diluted with water and then used. If the pH is determined to be higher than about 10, then a source of acid is added to the hypobromous acid-containing water to lower the pH of the hypobromous acid-containing water to about 6.5 to about 10. Any suitable source of acid may be used. Inorganic acids are preferred because they are less expensive than organic acids and possess higher pH-lowering properties. Suitable inorganic acids include solutions of sulfuric acid, hydrochloric acid, phosphoric acid, nitric acid, and sodium hydrogen sulfate. Preferable inorganic acids are phosphoric acid and sodium hydrogen sulfate because they are FDA-approved for food contact purposes. Organic acids may be used, and include citric acid and lactic acid, which are FDA-approved. After altering the pH, the step of bringing at least a portion of a poultry carcass into contact with the hypobromous acid-containing water is performed next.

Also, optionally, after the step of bringing at least a portion of a poultry carcass into contact with the hypobromous acid-containing water, a step of determining the pH of the hypobromous acid-containing water and a subsequent step of altering the pH may be performed. This pH-determining and pH-altering step is performed in the same manner as described above, and may be performed intermittently or continuously after the step of bringing at least a portion of a poultry carcass into contact with the hypobromous acid-containing water.

In another embodiment, a method of treating at least a portion of a poultry carcass in a reservoir during processing for increasing the weight of the poultry utilizes hypobromous acid. The method comprises:
(a) Providing, in a reservoir, a hypobromous acid-containing water having a pH of about 6.5 to about 10, wherein the hypobromous acid-containing water comprises water and an antimicrobial amount of an aqueous solution of hypobromous acid, and wherein the hypobromous acid-containing water has a temperature.

The solution of hypobromous acid may be prepared by mixing an aqueous solution of sodium bromide and a source of hypochlorite. Appropriate sources of hypochlorite include a solution of sodium hypochlorite, a solution of potassium hypochlorite, solid calcium hypochlorite, and solid lithium hypochlorite. Preferably, the aqueous sodium bromide and the source of hypochlorite are mixed in a mole ratio of about 1 to 1 to form a solution of hypobromous acid containing about 880 to about 197,200 ppm as Br₂.

A mineral acid may be added to lower the pH in order to accelerate the reaction of the sodium bromide mixture with the source of hypochlorite. Preferably, the mole ratio of the amount of protons introduced by the mineral acid to the amount of sodium bromide added is about 1 to about 1. Most preferably, the mole ratio of protons from the mineral acid to sodium bromide to the sodium hypochlorite solution is about 1 to about 1 to about 1. Suitable mineral acids include sulfuric, hydrochloric, nitric, and phosphoric acid. The acid may be introduced to the mixture by premixing it with the aqueous sodium bromide first, before introducing it to the source of hypochlorite; it may be added first, before the aqueous sodium bromide is introduced to the source of hypochlorite; it may be added after the introduction of the source of hypochlorite; or it may be added at the same time as the aqueous sodium bromide and the source of hypochlorite.

The hypobromous acid-containing water is provided in a reservoir. The reservoir may be any type of container suitable for cooling poultry during processing, such as a chill tank or other vessel. This may be accomplished in several ways. One way is to separately introduce the water, which may be softened, and the hypobromous acid solution into the reservoir. The hypobromous acid solution may be added to the reservoir simultaneously with the water or it may be added after the reservoir is filled with the water. Any means of introducing a liquid product to water can be used, such as a diaphragm pump, peristaltic pump, or a vacuum eductor to introduce the hypobromous acid solution into the reservoir water. Another way is to combine the water and the hypobromous acid solution outside the reservoir to form hypobromous acid-containing water and then introduce the hypobromous acid-containing water into the reservoir.

An antimicrobial amount of hypobromous acid is used. The amount is sufficient to prevent cross-contamination of bacteria between the poultry carcasses and to eradicate or reduce any pathogenic or spoilage microorganisms still resident on the carcasses. The amount of hypobromous acid that is used depends on the microbiological condition of the carcasses, but should be sufficient to provide about 1 ppm to about 99 ppm as Br₂ in the hypobromous acid-containing water. Any suitable method of analyzing the amount of hypobromous acid in the water can be used. These methods include test strips which change color depending on the amount hypobromous acid present, and the analytical methods described above in Experimental Methods.

The pH of the hypobromous acid-containing water that is formed is about 6.5 to about 10.

The hypobromous acid-containing water is preferably recirculated. A pump is used to recirculate the water through the reservoir, then through an external refrigeration unit where it is chilled, and then back to the reservoir. To maximize the efficiency of cooling the carcasses, the flow of chilled water should be opposite to the direction of movement of the carcasses through the reservoir.

The hypobromous acid-containing water is chilled to a temperature that is lower than the temperature of the carcasses just before they are placed into the reservoir and is maintained at this temperature. A preferable temperature is about 33-34° F. This may be accomplished by chilling the hypobromous acid-containing water in an external refrigeration unit during recirculation, chilling the water before the hypobromous acid solution is added to the water, or other methods.
(b) Placing into the hypobromous acid-containing water at least a portion of a poultry carcass having a first weight and having a first temperature greater than the temperature of the hypobromous acid-containing water.

A poultry carcass is placed into the hypobromous acid-containing water in the reservoir. Before it is placed into the reservoir, the poultry carcass has a specific weight referred to as a first weight, and has a specific temperature referred to as a first temperature. The first temperature is greater than the temperature of the hypobromous acid-containing water in the reservoir.

The carcasses may be rotated in the reservoir on an auger or may be turned or stirred by any other suitable method that will allow at least a portion of a carcass to come into contact with the hypobromous acid-containing water.

At any time after the poultry carcasses are placed into hypobromous acid-containing water, up to about ½ gallon of the hypobromous acid-containing water may be removed or bled off from the reservoir for each poultry carcass that enters the reservoir in order to keep the level of contaminants, such as blood, fecal matter, and ingesta, in the hypobromous acid-containing water at an acceptable level. Additional water (make-up water) is introduced into the reservoir to maintain the volume of water in the reservoir, and additional hypobromous acid is introduced into the reservoir as needed to keep the amount of hypobromous acid at about 1 ppm to about 99 ppm to continue to provide sufficient antimicrobial efficacy. The make-up water and the hypobromous acid may be introduced separately into the reservoir or they may be combined outside the reservoir to form hypobromous acid-containing water which is then introduced into the reservoir. The amount of hypobromous acid that will need to be added and the frequency of addition depend on the number of carcasses in the reservoir and the microbial condition of the carcasses. Any suitable method of analyzing the amount of hypobromous acid in the water can be used, including the methods described in step (a) above. The bleeding off of the hypobromous acid-containing water may be repeated or may be performed continuously. The hypobromous acid-containing water that is bled off may be reused in any processing step that is upstream from (earlier than) the reservoir from which it is removed.
(c) Allowing the hypobromous acid-containing water having the pH of about 6.5 to about 10 to increase the first weight of at least the portion of the poultry carcass to a second weight greater than the first weight to provide an increased weight of at least the portion of the poultry carcass and to lower the first temperature of at least the portion of the poultry carcass to a second temperature less than the first temperature for cooling at least the portion of the poultry carcass.

The poultry carcasses are left in the hypobromous acid-containing water in the reservoir until they are cooled to a second temperature, preferably about 33-34° F. The amount of time required for cooling depends on the number of carcasses in the reservoir, the size of the carcasses, and other factors. Typically, chickens are left in a chill tank for about 30-45 minutes, while turkeys are left longer, for up to about three hours. While the poultry carcasses are in the hypobromous acid-containing water in the reservoir, the weight of the poultry carcasses increases to a second weight which is greater than the first weight.
(d) Removing at least the portion of the poultry carcass having the increased weight from the hypobromous acid-containing water.

The poultry carcasses are removed from the hypobromous acid-containing water. Each poultry carcass has an increased weight because the second weight, which is the weight of a carcass after removal from the hypobromous acid-containing water, is greater than the first weight, which is the weight of a carcass before being placed into the hypobromous acid-containing water.

Optionally, before the step of placing at least the portion of the poultry carcass into the hypobromous acid-containing water, a step of determining the pH of the hypobromous acid-containing water and a subsequent step of altering the pH may be performed. The pH of the hypobromous acid-containing water is determined by any method, including the use of a glass electrode, indicator solutions, and pH test strips. If the pH is determined to be about 6.5 to about 10, then no pH-altering step is performed and the step of placing at least the portion of the poultry carcass into the hypobromous acid-containing water is performed next. If the pH is determined to be lower than about 6.5 or higher than about 10, then a subsequent pH-altering step is performed. If the pH is determined to be lower than about 6.5, then a source of alkali is added to the hypobromous acid-containing water to raise the pH of the hypobromous acid-containing water to about 6.5 to about 10. Any suitable source of alkali may be used. Examples include, but are not limited to, alkali metal or earth alkali metal carbonates, bicarbonates, oxides, and hydroxides. When solutions are preferred, sodium hydroxide or potassium hydroxide solutions are convenient to use, alone or in combination with each other. A preferred alkaline source is 50% NaOH solution. To prevent crystallization problems upon storage in cold climates, the 50% NaOH solution may be diluted with water and then used. If the pH is determined to be higher than about 10, then a source of acid is added to the hypobromous acid-containing water to lower the pH of the hypobromous acid-containing water to about 6.5 to about 10. Any suitable source of acid may be used. Inorganic acids are preferred because they are less expensive than organic acids and possess higher pH-lowering properties. Suitable inorganic acids include solutions of sulfuric acid, hydrochloric acid, phosphoric acid, nitric acid, and sodium hydrogen sulfate. Preferable inorganic acids are phosphoric acid and sodium hydrogen sulfate because they are FDA-approved for food contact purposes. Organic acids may be used, and include citric acid and lactic acid, which are FDA-approved. After altering the pH, the step of placing at least a portion of a poultry carcass into the hypobromous acid-containing water is performed next.

Also, optionally, after the step of placing at least a portion of a poultry carcass into the hypobromous acid-containing water, a step of determining the pH of the hypobromous acid-containing water and a subsequent step of altering the pH may be performed. This pH-determining and pH-altering step is performed in the same manner as described above, and may be performed intermittently or continuously after the step of placing at least a portion of a poultry carcass into the hypobromous acid-containing water.

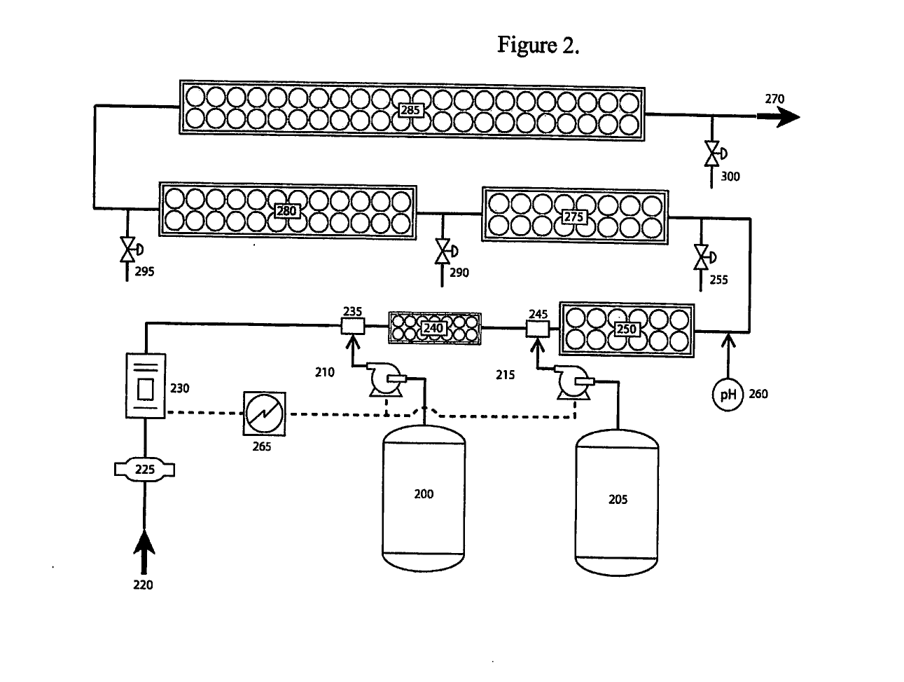

FIG. 2 is a schematic representation of an example of a system used in an embodiment of one of the methods to continuously or intermittently prepare a solution of hypobromous acid using aqueous sodium bromide for use in a poultry chill tank.

A container 200 of aqueous sodium bromide and a container 205 of 12.5% sodium hypochlorite were each equipped with chemical delivery diaphragm pumps 210 and 215, respectively. Inlet water 220, which may be softened to remove hardness cations, was provided from a water source on the site having the point-of-use. Inlet water 220 was directed through a pressure regulator 225 and flow meter 230, then into a section of pipe where the aqueous solution of sodium bromide was introduced through injection quill 255. Mixing was accomplished using static mixer 240. Then, the sodium hypochlorite solution was added through injection quill 245 to form a reaction medium.

The aqueous sodium bromide and the sodium hypochlorite solution may be added in a sequential manner as described, where the aqueous sodium bromide was added first, or they may be added to the water simultaneously through a “T” fitting placed before static mixer 240. If a T fitting is used, the aqueous sodium bromide and the sodium hypochlorite solution are introduced to opposite ends of the T fitting and the mixture is injected into the pipe of water. In other embodiments, the aqueous sodium bromide and may be added separately, or sequentially, with either one first, or simultaneously, with the aqueous sodium bromide added either simultaneously with, or after, the sodium hypochlorite solution.

The reaction medium was introduced to a residence chamber 250 which provided reaction time and contained a packing material to promote mixing. Residence chamber 250 was designed to be of a volume such that depending on the flow rate of the water, by the time the reaction medium reached sampling port 255 sufficient time had elapsed to allow substantial conversion of the aqueous sodium bromide into hypobromous acid. A pH probe 260 monitored the pH of the mixture. If the pH of the reaction medium was considered to be too high, an aqueous solution of a mineral acid such as hydrochloric, sulfuric, nitric or phosphoric acid may be introduced. The acid may be added first, before the aqueous sodium bromide injection quill, or it may be added after the introduction of the sodium hypochlorite solution, or it may be added at same time as the aqueous sodium bromide and the sodium hypochlorite solution.

A controller 265 was interfaced to the flow meter 230 of the inlet water 220, and also to the chemical delivery diaphragm pumps 210 and 215. The controller 265 monitored the rate of the inlet water 220 and governed the rate at which the aqueous sodium bromide and the sodium hypochlorite solutions were introduced. If the flow of inlet water 220 decreased because of lower hypobromous acid requirements at the point-of-use 195, the rates at which the aqueous sodium bromide and the sodium hypochlorite solution were pumped decreased accordingly. If the flow of inlet water 220 increased because of higher hypobromous acid and/or mixture of hypobromous acid and hypobromite requirements at the poultry chill tank 270, the rates at which the aqueous sodium bromide and the sodium hypochlorite solution were pumped increased accordingly. If the flow of inlet water 220 stopped, pumps 210 and 215 stopped. Thus, the generation of hypobromous acid and/or mixture of hypobromous acid and hypobromite was both continuous and intermittent, and was tailored to the requirements at the poultry chill tank.

The rate of the reaction between the aqueous sodium bromide and the sodium hypochlorite to form hypobromous acid is dependent upon the temperature of inlet water 220. If the temperature of inlet water 220 is high (for example, about 70° F.), the maximum conversion of the aqueous sodium bromide into hypobromous acid may occur after a few minutes, in which case the entire reaction medium was directed to the poultry chill tank 270. However, if the temperature of inlet water 220 is low (for example, about 32° F.), longer reaction times may be necessary to maximize the conversion of aqueous sodium bromide into hypobromous acid. Then, the reaction medium was directed through one or more residence chambers 275, 280, and 285 which also contained a packing material to promote turbulence and cause thorough mixing. Residence chambers 275, 280, and 285 were designed to be of volumes such that depending upon the flow rate of the inlet water, the conversion of aqueous sodium bromide into hypobromous acid reached a maximum by the time the reaction medium had reached one of the sampling ports 290, 295, or 300.

Thus, depending on the temperature of the inlet water, the time to achieve the maximum conversion of aqueous sodium bromide into hypobromous acid was determined by sampling and analyzing the solution at sample ports 255, 290, 295, and 300. The entire flow was then directed from the sampling port with the maximum conversion of aqueous sodium bromide into hypobromous acid to the poultry chill tank 270. In practice, the hypobromous acid generated from the reaction of aqueous sodium bromide and sodium hypochlorite solution is typically diluted at the poultry chill tank 270.

### Examples

### Example 6

This example shows that treating poultry carcasses in chilled hypobromous acid-containing water (100 ppm as bromine) having a pH of 6.5, 8.25 or 10, prepared by combining aqueous sodium bromide and sodium hypochlorite, provided an increase in weight of the poultry carcasses in addition to providing antibacterial benefits.

Thirty freshly killed chickens that had been picked (defeathered) and eviscerated were removed from a processing line at a poultry processing plant before they entered the plant's chicken chill tank. The chickens, which were still warm from body temperature, were prepared and weighed as described in Example 4.

Three 30-gallon bins, labeled Bin 1 (pH 6.25), Bin 2 (pH 8.25), and Bin 3 (pH 10), were filled with a combination of ice and soft water (20 L) which was enough volume to submerge 20 chicken halves at each pH. The temperature of the water in the bins was 42° F., simulating a poultry chill tank. The temperature of the water was monitored and kept constant using frozen bottles of water as ice packs.

The Salmonella typhimurium inoculum was prepared as described in Example 4. The amount of the Salmonella typhimurium was measured in the Salmonella inoculum by plating using 3M Petrifilm Enterobacteriaceae plates and incubated at 35° C. for 24 hours, upon which the plates were enumerated. The amount of Salmonella typhimurium in the inoculum was 2.82×10⁸ CFU/mL (log₁₀ 8.45).

The three bins were inoculated with Salmonella typhimurium inoculum (166.5 g) and mixed manually. The amount of the Salmonella typhimurium was measured in the Salmonella inoculated water by plating and enumerating as described for the inoculum. The chicken halves were then placed into the three respective bins, pH 6.5, 8.25, and 10, before the hypobromous acid was introduced.

The hypobromous acid was prepared by combining aqueous sodium bromide and sodium hypochlorite solution in a mole ratio of about 1 to about 1. A solution of 40% sodium bromide (200 g) was mixed with a solution of 13.4% sodium hypochlorite (452 g). No additional water was added. The hypobromous acid contained about 197,200 ppm as Br₂. The hypobromous acid solution was then used to dose the three bins to a nominal 100 ppm as Br₂, by introducing the hypobromous acid to the chilled water of each bin and manually mixing with a plastic rod to form hypobromous acid-containing water. The amount of hypobromous acid solution introduced to each bin was 10.14 g. The initial concentrations of hypobromous acid (as Br₂), measured using the modified DPD method, were 101.30 ppm, 118.10 ppm, and 114.80 ppm, for Bin 1, Bin 2, and Bin 3, respectively. The pHs of the hypobromous acid-containing water with the chickens before altering were measured to be 7.6, 7.4, and 7.4, for Bin 1, Bin 2, and Bin 3, respectively. The target pHs for the bins were 6.5, 8.25, and 10, for Bin 1, Bin 2, and Bin 3, respectively. The pHs of Bin 1, Bin 2, and Bin 3 were altered to 6.51 (with 37% hydrochloric acid), 8.15 (with 50% sodium hydroxide), and 10.07 (with 50% sodium hydroxide), respectively.

The chicken halves were soaked as described in Example 4. The amount of the Salmonella typhimurium remaining was measured at 0 minutes, 10 minutes, 1 hour, 2 hours, and 3 hours after placement of the chicken halves in the bins, by removing an aliquot of the chilled water followed by serial dilution (except for the zero dilution) and plating and enumerating as previously described. After 3 hours, the final concentrations of hypobromous acid (as Br₂) were 9.00 ppm, 11.25 ppm, and 20.25 ppm, for Bin 1, Bin 2, and Bin 3, respectively, and the final pHs were 6.56, 8.20, and 9.92, respectively.

After three hours, each chicken half was removed for weighing as described in Example 4.

Table XII summarizes the results. The standard errors for each set of data are also shown.

TABLE XII

| | Bin 1 | Bin 2 | Bin 3 |
|---|---|---|---|
| | (pH 6.5) | (pH 8.25) | (pH 10) |
| # Chicken Halves | 20 | 20 | 20 |
| Avg. Weight of | 747.13 | 694.02 | 717.84 |
| Chicken Half | | | |
| Before Chill/g | | | |
| Avg. Weight of | 775.54 | 739.74 | 783.55 |
| Chicken Half | | | |
| After Chill/g | | | |
| Avg. Weight Gain/g | 28.42 | 45.72 | 65.71 |
| Average | 3.93 | 6.54 | 9.277 |
| % Weight Gain | | | |
| Standard | 0.344 | 0.545 | 0.434 |
| Error ± % | | | |

Table XIII summarizes the efficacy data for the three bins, and shows the results for the pre-treated inoculated water, immediately after administering the hypobromous acid, ten minutes, one hour, two hours, and three hours after administering the hypobromous acid (termination of the study).

TABLE XIII

| | Theoretical | | log₁₀ | log₁₀ | % |
|---|---|---|---|---|---|
| Bin | pH | Description | Remaining | Reduction | Reduction |
| Bin 1 | 6.5 | Pre-Treated | 4.82 | N/A | N/A |

| | | | | |
|---|---|---|---|---|
| 0 | min | 2.17 | 2.65 | 99.77 |
| 10 | min | 1.04 | 3.78 | 99.98 |
| 1 | hr | 1.70 | 3.12 | 99.92 |
| 2 | hr | 1.39 | 3.43 | 99.96 |
| 3 | hr | 1.57 | 3.25 | 99.94 |

| | | | | | |
|---|---|---|---|---|---|
| Bin 2 | 8.25 | Pre-Treated | 4.69 | N/A | N/A |

| | | | | |
|---|---|---|---|---|
| 0 | min | 2.07 | 2.62 | 99.76 |
| 10 | min | 1.32 | 3.37 | 99.96 |
| 1 | hr | 1.56 | 3.13 | 99.93 |
| 2 | hr | 0.85 | 3.84 | 99.986 |
| 3 | hr | 1.11 | 3.58 | 99.97 |

| | | | | | |
|---|---|---|---|---|---|
| Bin 3 | 10 | Pre-Treated | 3.83 | N/A | N/A |

| | | | | |
|---|---|---|---|---|
| 0 | min | 2.25 | 1.58 | 97.37 |
| 10 | min | 1.15 | 2.68 | 99.79 |
| 1 | hr | 1.95 | 1.88 | 98.68 |
| 2 | hr | 0.60 | 3.23 | 99.94 |
| 3 | hr | 1.74 | 2.09 | 99.19 |

Table XIII shows that the high level of approximately 100 ppm Br₂ from hypobromous acid was effective at reducing the level of Salmonella typhimurium at pH 6.5, 8.25, and 10, immediately after the initial dose, at ten minutes, one hour, two hours, and three hours.

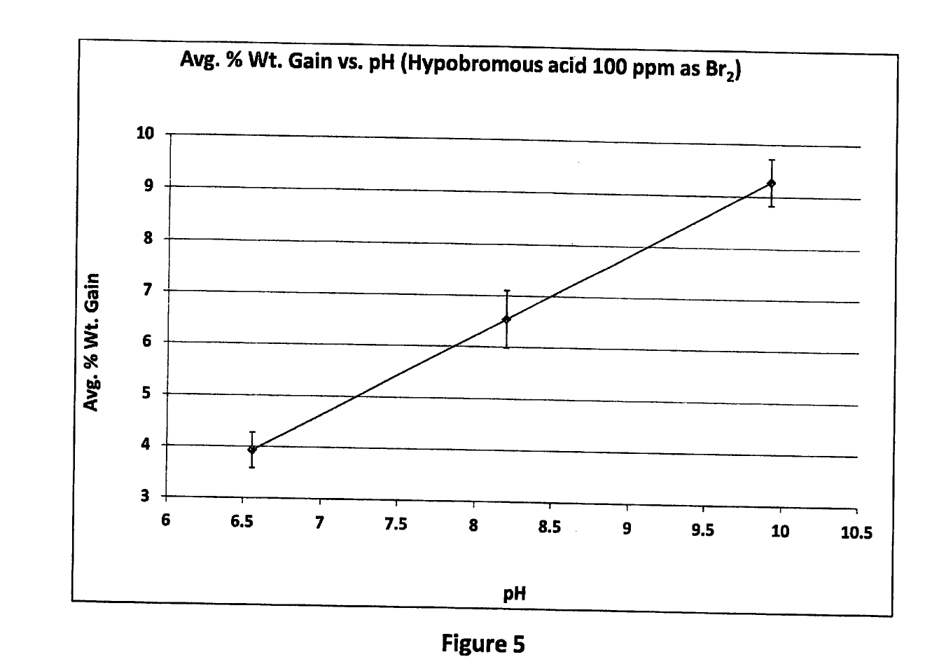

FIG. 5 shows the average percent weight gain of the chicken halves versus pH. The squares represent the average percent weight gain. The error bars represent the standard error, also referred to as the standard deviation of the average.

The statistical analysis was performed using the “Two Sample Assuming Un-Equal Variances” t-test (Analysis ToolPak, Microsoft Excel, 2007).

The t-test results are displayed in Tables XIV, XV, and XVI. The t-test calculated the average percent weight gained by the chicken halves for each data set, the variance, number of replicates, degrees of freedom (df), t-stat value, and the P two-tail value.

The P (two-tail)-value refers to the confidence level calculated by the t-test. It provides the level of confidence that the averages of the percent weight gain of chicken halves soaked in hypobromous acid-containing water at the different pHs are statistically different and not just chance findings.

Table XIV displays the t-test results when Bin 2 (pH 8.25) was compared to Bin 1 (pH 6.5).

TABLE XIV
t-Test: Two-Sample Assuming Unequal Variances

| | 100 ppm Br₂ | 100 ppm Br₂ |
|---|---|---|
| | (pH 8.25) | (pH 6.5) |
| Mean | 6.541936 | 3.931903 |
| Variance | 6.248403 | 2.367464 |
| Observations | 20 | 20 |
| df | 32 | |
| t Stat | 3.976597 | |
| P(T <= t) two-tail | 0.000374 | |
| t Critical two-tail | 2.036933 | |

Using a t-table, the confidence level was approximated. The t-value (3.98) exceeded the 99.9% confidence levels with a t-stat value of 2.04. To determine the exact confidence level, the P-value was used in the determination (100%−0.04%), thus, the confidence level is established at 99.96% that the average percent weight gain of chicken halves soaked in hypobromous acid-containing water at pH 6.5 and pH 8.25 are statistically different.

Table XV displays the t-test results when Bin 3 (pH 10) was compared to Bin 1 (6.25).

TABLE XV
t-Test: Two-Sample Assuming Unequal Variances

| | 100 ppm Br₂ | 100 ppm Br₂ |
|---|---|---|
| | (pH 10) | (pH 6.5) |
| Mean | 9.276759 | 3.931903 |
| Variance | 3.958687 | 2.367464 |
| Observations | 20 | 20 |
| df | 36 | |
| t Stat | 9.503449 | |
| P(T <= t) two-tail | 2.38E−11 | |
| t Critical two-tail | 2.028094 | |

Using a t-table, the confidence level was approximated. The t-value (9.50) exceeded the 99.9% confidence levels with a t-stat value of 2.03. To determine the exact confidence level, the P-value was used in the determination (100%−0.000000002%), thus, the confidence level is established at >99.99999% that the average percent weight gain of chicken halves soaked in hypobromous acid-containing water at pH 6.5 and pH 10 are statistically different.

Table XVI displays the t-test results when Bin 3 (pH 10) was compared to Bin 2 (pH 8.25).

TABLE XVI

| | 100 ppm Br₂ | 100 ppm Br₂ |
|---|---|---|
| | (pH 10) | (pH 8.25) |
| Mean | 9.276759 | 6.541936 |
| Variance | 3.958687 | 6.248403 |
| Observations | 20 | 20 |
| df | 36 | |
| t Stat | 3.828187 | |
| P(T <= t) two-tail | 0.000496 | |
| t Critical two-tail | 2.028094 | |

Using a t-table, the confidence level was approximated. The t-value (3.83) exceeded the 99.9% confidence levels with a t-stat value of 2.03. To determine the exact confidence level, the P-value was used in the determination (100%−0.05%), thus, the confidence level is established at >99.95% that the average percent weight gain of chicken halves soaked in hypobromous acid-containing water at pH 8.25 and pH 10 are statistically different.

### Example 7

This example shows that treating poultry carcasses in chilled hypobromous acid-containing water (1 ppm as bromine) having a pH of 6.5, 8.25 or 10, prepared by combining aqueous sodium bromide and sodium hypochlorite, provided an increase in weight of the poultry carcasses in addition to providing antibacterial benefits.

Thirty freshly killed chickens that had been picked (defeathered) and eviscerated were removed from a processing line at a poultry processing plant before they entered the plant's chicken chill tank. The chickens, which were still warm from body temperature, were prepared and weighed as described in Example 4.

Three 30-gallon bins, labeled Bin 1 (pH 6.5), Bin 2 (pH 8.25), and Bin 3 (pH 10), were filled with a combination of ice and soft water (20 L) which was enough volume to submerge 20 chicken halves at each pH. The temperature of the water in the bins was 42° F., simulating a poultry chill tank. The temperature of the water was monitored and kept constant using frozen bottles of water as ice packs.

The Salmonella typhimurium inoculum was prepared as described in Example 4. The amount of the Salmonella typhimurium was measured in the Salmonella inoculum by plating using 3M Petrifilm Enterobacteriaceae plates and incubated at 35° C. for 24 hours, upon which the plates were enumerated. The amount of Salmonella typhimurium in the inoculum was 2.75×10⁸ CFU/mL (log₁₀ 8.44).

The three bins were inoculated with Salmonella typhimurium inoculum (166.5 g) and mixed manually. The amount of the Salmonella typhimurium was measured in the Salmonella inoculated water by plating and enumerating as described for the inoculum. The chicken halves were then placed into the three respective bins, pH 6.5, 8.25, and 10, before the hypobromous acid was introduced.

The hypobromous acid was prepared by combining aqueous sodium bromide and sodium hypochlorite in a mole ratio of about 1 to about 1. A solution of 40% sodium bromide (200 g) was mixed with a solution of 13.7% sodium hypochlorite (442 g). No additional water was added. The hypobromous acid contained about 196,900 ppm as Br₂. The hypobromous acid solution was then used to dose the three bins to a nominal 1 ppm as Br₂, by introducing the hypobromous acid to the chilled water of each bin and manually mixing with a plastic rod to form hypobromous acid-containing water. The amount of hypobromous acid solution introduced to each bin was 0.102 g. The initial concentrations of hypobromous acid (as Br₂), measured using the modified DPD method, were 1.17 ppm, 1.22 ppm, and 1.13 ppm, for Bin 1, Bin 2, and Bin 3, respectively. The pHs of the hypobromous acid-containing water with the chickens before altering were measured to be 7.4, 7.3, and 7.5, for Bin 1, Bin 2, and Bin 3, respectively. The target pHs for the bins were 6.5, 8.25, and 10, for Bin 1, Bin 2, and Bin 3, respectively. The pHs of Bin 1, Bin 2, and Bin 3 were altered to 6.45 (with 37% hydrochloric acid), 8.30 (with 50% sodium hydroxide), and 10.03 (with 50% sodium hydroxide), respectively.

The chicken halves were soaked as described in Example 4. The amount of the Salmonella typhimurium remaining was measured at 0 minutes, 10 minutes, 1 hour, 2 hours, and 3 hours after placement of the chicken halves in the bins, by removing an aliquot of the chilled water followed by serial dilution (except for the zero dilution) and plating and enumerating as previously described. A calculated amount of hypobromous acid was added to the bins to keep the concentration at a nominal 1 ppm as Br₂. After 3 hours, the final concentrations of hypobromous acid (as Br₂), measured using the modified DPD method, were 1.04 ppm, 0.96 ppm, and 1.04 ppm, for Bin 1, Bin 2, and Bin 3, respectively, and the final pHs was 6.52, 8.00, and 10.02, respectively.

After three hours, each chicken half was removed for weighing as described in Example 4.

Table XVII summarizes the results. The standard errors for each set of data are also shown.

TABLE XVII

| | Bin 1 | Bin 2 | Bin 3 |
|---|---|---|---|
| | (pH 6.5) | (pH 8.25) | (pH 10) |
| # Chicken Halves | 20 | 20 | 20 |
| Avg. Weight of | 829.00 | 868.30 | 822.50 |
| Chicken Half | | | |
| Before Chill/g | | | |
| Avg. Weight of | 880.83 | 942.26 | 913.34 |
| Chicken Half | | | |
| After Chill/g | | | |
| Avg. Weight Gain/g | 51.83 | 73.90 | 90.85 |
| Average | 6.32 | 8.51 | 11.12 |
| % Weight Gain | | | |
| Standard | 0.352 | 0.386 | 0.639 |
| Error ± % | | | |

Table XVIII summarizes the efficacy data for the three bins, and shows the results for the pre-treated inoculated water, immediately after administering the hypobromous acid, ten minutes, one hour, two hours, and three hours after administering the hypobromous acid (termination of the study).

TABLE XVIII

| | Theoretical | | log₁₀ | log₁₀ | % |
|---|---|---|---|---|---|
| Bin | pH | Description | Remaining | Reduction | Reduction |
| Bin 1 | 6.5 | Pre-Treated | 5.24 | N/A | N/A |

| | | | | |
|---|---|---|---|---|
| 0 | min | 4.27 | 0.97 | 89.28 |
| 10 | min | 4.36 | 0.88 | 86.82 |
| 1 | hr | 4.32 | 0.92 | 87.98 |
| 2 | hr | 4.37 | 0.87 | 86.51 |
| 3 | hr | 4.25 | 0.99 | 89.77 |

| | | | | | |
|---|---|---|---|---|---|
| Bin 2 | 8.25 | Pre-Treated | 4.95 | N/A | N/A |

| | | | | |
|---|---|---|---|---|
| 0 | min | 4.35 | 0.60 | 74.88 |
| 10 | min | 4.58 | 0.37 | 57.34 |
| 1 | hr | 4.45 | 0.50 | 68.38 |
| 2 | hr | 4.32 | 0.63 | 76.56 |
| 3 | hr | 4.32 | 0.63 | 76.56 |

| | | | | | |
|---|---|---|---|---|---|
| Bin 3 | 10 | Pre-Treated | 5.16 | N/A | N/A |

| | | | | |
|---|---|---|---|---|
| 0 | min | 4.86 | 0.30 | 49.88 |
| 10 | min | 4.69 | 0.47 | 66.12 |
| 1 | hr | 4.92 | 0.24 | 42.46 |
| 2 | hr | 4.56 | 0.60 | 74.88 |
| 3 | hr | 4.83 | 0.33 | 53.23 |

Table XVIII shows that the low level of approximately 1 ppm Br₂ from hypobromous acid was effective at reducing the level of Salmonella typhimurium at pH 6.5, 8.25, and 10, immediately after the initial dose, at ten minutes, one hour, two hours, and three hours.

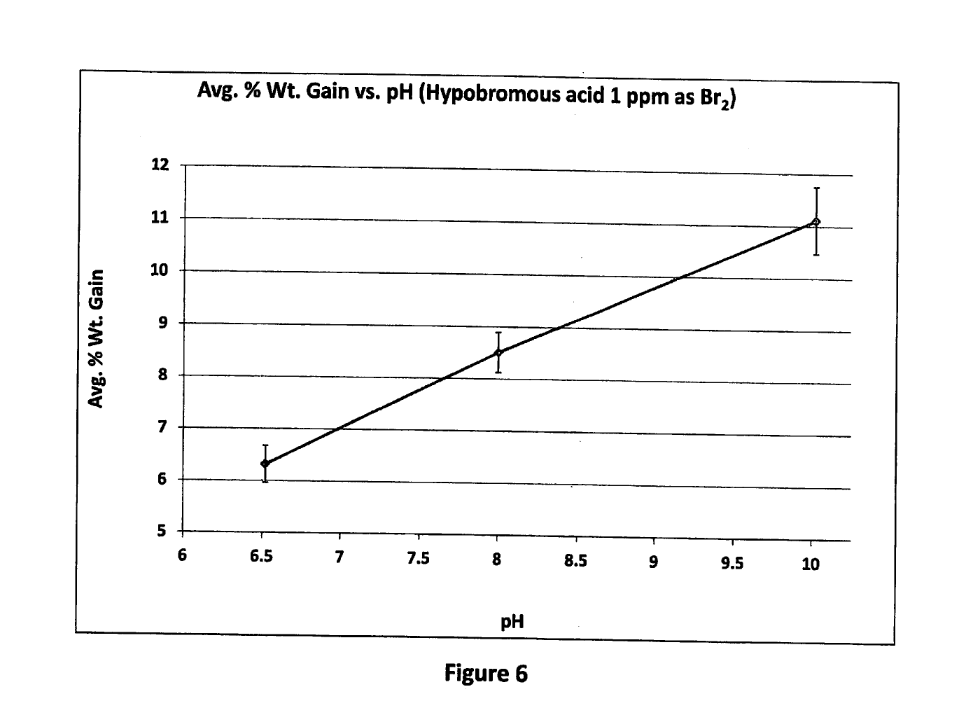

FIG. 6 shows the average percent weight gain versus pH. The squares represent the average percent weight gain. The error bars represent the standard error, also referred to as the standard deviation of the average.

The statistical analysis was performed using the “Two Sample Assuming Un-Equal Variances” t-test (Analysis ToolPak, Microsoft Excel, 2007).

The t-test results are displayed in Tables XIX, XX, and XXI. The t-test calculated the average percent weight gained by the chicken halves for each data set, the variance, number of replicates, degrees of freedom (df), t-stat value, and the P two-tail value.

The P (two-tail)-value refers to the confidence level calculated by the t-test. It provides the level of confidence that the averages of the percent weight gain of chicken halves soaked in hypobromous acid-containing water at the different pHs are statistically different and not just chance findings.

Table XIX displays the t-test results when Bin 2 (pH 8.25) was compared to Bin 1 (pH 6.5).

TABLE XIX
t-Test: Two-Sample Assuming Unequal Variances

| | 1 ppm Br₂ | 1 ppm Br₂ |
|---|---|---|
| | (pH 8.25) | (pH 6.5) |
| Mean | 8.509334146 | 6.315840989 |
| Variance | 2.983736766 | 2.484998182 |
| Observations | 20 | 20 |
| df | 38 | |
| t Stat | 4.194767015 | |
| P(T <= t) two-tail | 0.000157779 | |
| t Critical two-tail | 2.024394147 | |

Using a t-table, the confidence level was approximated. The t-value (4.19) exceeded the 99.9% confidence levels with a t-stat value of 2.02. To determine the exact confidence level, the P-value was used in the determination (100%−0.016%), thus, the confidence level is established at 99.984% that the average percent weight gain of chicken halves soaked in hypobromous acid-containing water at pH 6.5 and pH 8.25 are statistically different.

Table XX displays the t-test results when Bin 3 (pH 10) was compared to Bin 1 (pH 6.25).

TABLE XX
t-Test: Two-Sample Assuming Unequal Variances

| | 1 ppm Br₂ | 1 ppm Br₂ |
|---|---|---|
| | (pH 10) | (pH 6.5) |
| Mean | 11.11513676 | 9.733015709 |
| Variance | 8.160789636 | 3.906729769 |
| Observations | 20 | 20 |
| df | 30 | |
| t Stat | 6.57814755 | |
| P(T <= t) two-tail | 2.80477E−07 | |
| t Critical two-tail | 2.042272449 | |

Using a t-table, the confidence level was approximated. The t-value (6.58) exceeded the 99.9% confidence levels with a t-stat value of 2.04. To determine the exact confidence level, the P-value was used in the determination (100%−0.00003%), thus, the confidence level is established at 99.99997% that the average percent weight gain of chicken halves soaked in hypobromous acid-containing water at pH 6.5 and pH 10 are statistically different.

Table XXI displays the t-test results when Bin 3 (pH 10) was compared to Bin 2 (pH 8.25).

TABLE XXI
t-Test: Two-Sample Assuming Unequal Variances

| | 1 ppm Br₂ | 1 ppm Br₂ |
|---|---|---|
| | (pH 10) | (pH 8.25) |
| Mean | 11.11513676 | 8.509334146 |
| Variance | 8.160789636 | 2.983736766 |
| Observations | 20 | 20 |
| df | 31 | |
| t Stat | 3.49080593 | |
| P(T <= t) two-tail | 0.001468781 | |
| t Critical two-tail | 2.039513438 | |

Using a t-table, the confidence level was approximated. The t-value (3.49) is just at the 99.9% confidence levels with a t-stat value of 2.04. To determine the exact confidence level, the P-value was used in the determination (100%−0.15%), thus, the confidence level is established at 99.985% (˜99.9%) that the average percent weight gain of chicken halves soaked in hypobromous acid-containing water at 8.25 and pH 10 are statistically different.

The invention has been described above with the reference to the preferred embodiments. Those skilled in the art may envision other embodiments and variations of the invention that fall within the scope of the claims.

We claim:

1- A method of treating at least a portion of a poultry carcass for increasing the weight of the poultry, said method comprising:
combining water and an antimicrobial amount of an aqueous solution of hypobromous acid for forming a hypobromous acid-containing water;
determining the pH of the hypobromous acid-containing water, and, if the pH is determined to be lower than about 6.5 or higher than about 10, then altering the pH of the hypobromous acid-containing water to a pH of about 6.5 to about 10;
bringing at least a portion of a poultry carcass into contact with the hypobromous acid-containing water; and
determining the pH of the hypobromous acid-containing water with at least the portion of the poultry carcass therein, and, if the pH is determined to be lower than about 6.5 or higher than about 10, then altering the pH of the hypobromous acid-containing water to a pH of about 6.5 to about 10, for increasing the weight of at least the portion of the poultry carcass from a first weight prior to contact with the hypobromous acid-containing water to a second weight greater than the first weight after contact with the hypobromous acid-containing water.

2- The method of claim 1, wherein the aqueous solution of hypobromous acid comprises hypobromous acid.

3- The method of claim 1, wherein the aqueous solution of hypobromous acid comprises a mixture of hypobromous acid and hypobromite ion.

4- The method of claim 1, wherein the aqueous solution of hypobromous acid is prepared by mixing an aqueous solution of hydrogen bromide and a source of hypochlorite with water.

5- The method of claim 4, wherein the aqueous solution of hydrogen bromide and the source of hypochlorite are mixed in a mole ratio of about 1 to about 1.

6- The method of claim 1, wherein the aqueous solution of hypobromous acid is prepared by mixing an aqueous solution of sodium bromide and a source of hypochlorite.

7- The method of claim 6, wherein the aqueous solution of sodium bromide and the source of hypochlorite are mixed in a mole ratio of about 1 to about 1.

8- The method of claim 6, further comprising adding a mineral acid with the sodium bromide and the source of hypochlorite.

9- The method of claim 4, wherein the aqueous solution of hypobromous acid contains about 50 to about 30,000 ppm as Br₂.

10- The method of claim 6, wherein the aqueous solution of hypobromous acid contains about 880 to about 197,200 ppm as Br₂.

11- The method of claim 1, wherein the antimicrobial amount of the aqueous solution of hypobromous acid is sufficient to provide about 1 ppm to about 99 ppm as Br₂ in the hypobromous acid-containing water.
